(19) United States
(12) Patent Application Publication
(10) Pub. No.: US 2026/0195968 A1
(43) Pub. Date: Jul. 9, 2026

(54) GRAPHICS PROCESSING

(71) Applicant: Arm Limited, Cambridge (GB)

(72) Inventors: Gustaf Daniel WALDEMARSON, Cambridge (GB); Erik Elias HOGEMAN, Cambridge (GB); Max Micael Eric ANDERSSON, Cambridge (GB)

(73) Assignee: Arm Limited, Cambridge (GB)

(21) Appl. No.: 19/439,979

(22) Filed: Jan. 5, 2026

(30) Foreign Application Priority Data
Jan. 9, 2025 (GB) 2500269.2

(51) Int. Cl. G06T 15/06

(52) U.S. Cl. CPC G06T 15/06

(57) ABSTRACT

A graphics processing system that comprises a graphics processor operable to perform ray tracing is disclosed. Instructions of set of ray tracing shader programs that define different elements of a ray tracing pipeline are combined to generate a combined ray tracing shader program, and the combined ray tracing shader program is provided for execution by a graphics processor.

### BACKGROUND

The technology described herein relates to graphics processing systems, and in particular to the rendering of frames (images) for display using ray tracing.

Ray tracing is a rendering process which involves tracing the paths of rays of light from a viewpoint (sometimes referred to as a “camera”) back through sampling positions in an image plane into a scene, and simulating the effect of the interaction between the rays and objects in the scene. The output data value for a sampling position in the image (plane) is determined based on the object(s) in the scene intersected by the ray passing through the sampling position, and the properties of the surfaces of those objects. The ray tracing calculation is complex, and involves determining, for each sampling position, a set of zero or more objects within the scene which a ray passing through the sampling position intersects.

A graphics processor may typically perform ray tracing by a executing a set of ray tracing shader programs that together define a ray tracing pipeline. Such ray tracing shader programs may typically be initially provided in a high-level shader programming language (such as GLSL, HLSL, OpenCL, etc.), compiled to executable form, and provided to the graphics processor for execution in executable form.

Typically, a ray generation shader program will (when executed by the graphics processor) generate rays that are traversed through a ray tracing acceleration data structure to determine whether the rays intersect geometry represented by the ray tracing acceleration data structure. When a ray is found to intersect geometry represented by the ray tracing acceleration data structure, an appropriate hit shader program is identified and executed. The appropriate hit shader program to execute can depend on the geometry that has been intersected, and so to account for this, a shader binding table (SBT) is provided and used (inter alia) to identify which hit shader program to execute. Similarly, when a ray is found not to intersect any geometry represented by the ray tracing acceleration data structure, an appropriate miss shader program may be identified and executed.

Ray tracing is considered to provide better, e.g. more realistic, physically accurate images than more traditional rasterisation rendering techniques, particularly in terms of the ability to capture reflection, refraction, shadows and lighting effects. However, ray tracing can be significantly more processing-intensive than traditional rasterisation, and so it is usually desirable to be able to accelerate ray tracing.

The inventors accordingly believe that there remains scope for improved techniques for performing ray tracing using a graphics processor.

### BRIEF DESCRIPTION OF THE DRAWINGS

Embodiments of the technology described herein will now be described by way of example only and with reference to the accompanying drawings, in which:

FIG. 1 shows an exemplary graphics processing system;

FIG. 2 is a schematic diagram illustrating an exemplary ray tracing process;

FIG. 3 is a flowchart illustrating an overall ray tracing process;

FIG. 4A, FIG. 4B and FIG. 4C illustrate exemplary ray tracing acceleration data structures;

FIG. 5 illustrates schematically a ray tracing pipeline;

FIG. 6 shows schematically a graphics processor that can be operated in the manner of the technology described herein;

FIG. 7 illustrates schematically a process of compiling a shader program;

FIG. 8 illustrates schematically an exemplary ray tracing shader binding table (SBT);

FIG. 9 is a flow chart illustrating a ray tracing shader compilation process;

FIG. 10 is a flow chart illustrating a ray tracing shader execution process;

FIG. 11 is a flow chart illustrating a ray tracing shader compilation process in accordance with embodiments of the technology described herein;

FIG. 12 is a flow chart illustrating a ray tracing shader execution process in accordance with embodiments of the technology described herein;

FIG. 13 illustrates schematically a ray tracing shader call graph that may be generated in embodiments of the technology described herein;

FIG. 14 is a flow chart illustrating a ray tracing acceleration data structure generation process in accordance with embodiments of the technology described herein; and

FIG. 15 illustrates schematically a ray tracing shader compilation process in accordance with embodiments of the technology described herein.

### DETAILED DESCRIPTION

A first embodiment of the technology described herein comprises a method of providing a ray tracing shader program for execution by a graphics processor that is operable to perform ray tracing by executing ray tracing shader programs; the method comprising:
generating, from a set of ray tracing shader programs that define different elements of a ray tracing pipeline, a combined ray tracing shader program by combining instructions of different ray tracing shader programs of the set; and
providing the combined ray tracing shader program for execution by a graphics processor.

A second embodiment of the technology described herein comprises an apparatus for providing ray tracing shader programs for execution by a graphics processor that is operable to perform ray tracing by executing ray tracing shader programs; the apparatus comprising:
a generating circuit configured to generate, from a set of ray tracing shader programs that define different elements of a ray tracing pipeline, a combined ray tracing shader program by combining instructions of different ray tracing shader programs of the set; and
a providing circuit configured to provide a combined ray tracing shader program generated by the generating circuit for execution by a graphics processor.

In embodiments, the combined ray tracing shader program is executed by the graphics processor.

Thus, another embodiment of the technology described herein comprises a method of operating a graphics processing system that comprises a graphics processor that is operable to perform ray tracing by executing ray tracing shader programs; the method comprising:
generating, from a set of ray tracing shader programs that define different elements of a ray tracing pipeline, a combined ray tracing shader program by combining instructions of different ray tracing shader programs of the set;
providing the combined ray tracing shader program for execution by the graphics processor; and
the graphics processor executing the combined ray tracing shader program.

Another embodiment of the technology described herein comprises a graphics processing system comprising:
a graphics processor operable to perform ray tracing by executing ray tracing shader programs; and
a processing circuit operable to provide ray tracing shader programs for execution by the graphics processor;
wherein the processing circuit is configured to:
   generate, from a set of ray tracing shader programs that define different elements of a ray tracing pipeline, a combined ray tracing shader program by combining instructions of different ray tracing shader programs of the set; and
   provide the combined ray tracing shader program for execution by the graphics processor; and
wherein the graphics processor is configured to execute a combined ray tracing shader program provided by the processing circuit.

Further embodiments comprise a graphics processor executing a combined ray tracing shader program provided as above.

Thus, another embodiment comprises a method of operating a graphics processor that is operable to perform ray tracing by executing ray tracing shader programs; the method comprising:
the graphics processor executing a combined ray tracing shader program;
wherein the combined ray tracing shader program is generated from a set of ray tracing shader programs that define different elements of a ray tracing pipeline, by combining instructions of different ray tracing shader programs of the set.

Another embodiment comprises a graphics processor that is operable to perform ray tracing by executing ray tracing shader programs;
wherein the graphics processor is configured to execute a combined ray tracing shader program;
wherein the combined ray tracing shader program is generated from a set of ray tracing shader programs that define different elements of a ray tracing pipeline, by combining instructions of different ray tracing shader programs of the set.

The technology described herein is concerned with performing ray tracing. In the technology described herein, a graphics processor is operable to perform ray tracing by executing ray tracing shader programs.

As discussed above, a ray tracing shader program may be initially provided in high-level form, and translated (compiled) to executable form for execution by the graphics processor. A (the) graphics processing system may thus include a (the) processing circuit (e.g. compiler) that provides (e.g. compiles) ray tracing shader programs for execution by the graphics processor (in executable form).

As also discussed above, a ray tracing pipeline may be (initially) defined by a set of ray tracing shader programs that define different elements of a ray tracing pipeline, e.g. including one or more ray generation shader programs, one or more hit shader programs, and one or more miss shader programs.

Typically, each ray tracing shader program of the set may be translated (compiled) separately, and the resulting separate executable ray tracing shader programs provided to the graphics processor for execution. The graphics processor may then initially execute a ray generation shader program, execute a (separate) hit shader program when a ray is found to intersect geometry, and execute a (separate) miss shader program when a ray is found not to intersect any geometry, etc..

In the technology described herein, a ray tracing pipeline that is (initially) defined by a set of different ray tracing shader programs is implemented by (the generating/processing circuit (e.g. compiler)) (attempting to) combining instructions of the different ray tracing shader programs to generate a (e.g. single) combined ray tracing shader program that (when executed by the graphics processor) can (itself) implement plural different elements of the ray tracing pipeline, e.g. and in embodiments the complete ray tracing pipeline. Thus, in embodiments, a (complete) ray tracing pipeline is implemented by the graphics processor executing a single executable ray tracing shader program, e.g. without executing any other (separate) executable ray tracing shader program.

As will be discussed in more detail below, the inventors have found that it is possible to combine separate ray tracing shader programs defining different elements of a ray tracing pipeline into a (e.g. single) combined ray tracing shader program that can (itself) implement plural elements of a, e.g. complete, ray tracing pipeline, and that doing so can increase opportunities for compiler optimisations, e.g. as compared to compiling the ray tracing shader programs separately. The inventors have furthermore recognised that providing and executing a (e.g. single) combined ray tracing shader program can avoid the graphics processor switching between execution of separate executable shader programs to implement a ray tracing pipeline, and that this can facilitate improved execution efficiency. The technology described herein can thus improve efficiency and accelerate ray tracing.

It will be appreciated, therefore, that the technology described herein can provide an improved graphics processing system and ray tracing method.

The graphics processor (GPU) may be arranged in any suitable manner. In embodiments, the graphics processor (GPU) comprises one or more, e.g. plural, processing cores (e.g. shader cores). A (each) processing core may be (a shader core) operable to perform graphics processing operations by executing shader program instructions. There may be any suitable number of processing cores, such as 1, 2, 4, 8, 16, 32 or another number. In embodiments, a (each) processing core comprises one or more execution units (execution engines) that are operable to execute shader program instructions.

The graphics processor may form part of a (the) graphics processing system that may comprise a host processor, e.g. a central processing unit (CPU). The host processor (e.g. CPU) may execute applications that can require graphics processing by the graphics processor (GPU), and send appropriate commands and data to the graphics processor (GPU) to control it to perform graphics processing operations and to produce graphics processing (render) output required by applications executing on the host processor (CPU).

To facilitate this, the host processor (CPU) in embodiments also executes a driver for the graphics processor (GPU). Thus, in embodiments, the graphics processing system comprises a graphics processor (GPU) that is in communication with a host microprocessor (CPU) that executes a driver for the graphics processor (GPU).

A (each) operation of the technology described herein may be performed by the graphics processor (GPU), and/or host processor (CPU), and/or another component of the graphics processing system, as appropriate. Correspondingly, a (each) circuit of the technology described herein may form part of the graphics processor (GPU), and/or host processor (CPU), and/or another component of the graphics processing system, as appropriate.

In embodiments, the driver for the graphics processor (that is executing on the host processor (CPU)) is operable as (comprises) a compiler that receives and compiles (high-level) ray tracing shader programs, and provides (compiled) ray tracing shader programs in executable form for execution by the graphics processor.

Thus, in embodiments, the host processor (e.g. CPU) comprises or is the apparatus/processing circuit (e.g. compiler). In embodiments, the apparatus/processing circuit (driver/compiler) is operable to, upon receiving a set of (e.g. high-level) ray tracing shader programs that together define a ray tracing pipeline, wherein different ray tracing shader programs of the set define different elements of the ray tracing pipeline: (attempt to) combine instructions of different ray tracing shader programs of the set to generate a combined ray tracing shader program that will (when executed by the graphics processor) cause the graphics processor to implement (plural elements of) a (e.g. complete) ray tracing pipeline; and provide (e.g. compile) the combined ray tracing shader program for execution by the graphics processor (in executable form).

In embodiments of the technology described herein, the graphics processing system/processor is operable to perform ray tracing, e.g. and in embodiments, in order to generate a render output, such as a frame for display, e.g. that represents a view of a scene comprising one or more objects. The graphics processing system/processor may typically generate plural render outputs, e.g. a series of frames.

A render output will typically comprise an array of data elements (sampling points) (e.g. pixels), for each of which appropriate render output data (e.g. a set of colour value data) is generated by the graphics processing system/processor. A render output data may comprise colour data, for example, a set of red, green and blue, RGB values and a transparency (alpha, a) value.

Typically in ray tracing, one or more rays are used to render a (each) sampling position in the render output, and for each ray being traced, it is determined whether/which geometry that is defined for the render output is intersected by the ray. Geometry determined to be intersected by a ray may be further processed, e.g. in order to determine a colour for the sampling position in question.

The geometry to be processed to generate a render output may comprise any suitable and desired graphics processing geometry. In embodiments, the geometry comprises graphics primitives, in embodiments in the form of polygons, such as triangles.

In general, there may be many millions of graphics primitives within a given scene, and millions of rays to be tested, such that it is not normally practical to test every ray against each and every graphics primitive. To speed up the ray tracing operation, embodiments of the technology described herein use a ray tracing acceleration data structure, such as a bounding volume hierarchy (BVH), that is representative of the distribution of the geometry in the scene that is to be rendered to determine the intersection of rays with geometry (e.g. objects) in the scene being rendered (and then render sampling positions in the output rendered frame representing the scene accordingly). Thus, in embodiments, the graphics processor is operable to perform ray tracing by traversing rays through a ray tracing acceleration data structure.

A (the) ray tracing acceleration data structure may be generated by the same graphics processor that then traverses the ray tracing acceleration data structure. Alternatively, a (the) ray tracing acceleration data structure may be generated by a different data processor to the graphics processor that traverses the ray tracing acceleration data structure. For example, a ray tracing acceleration data structure may be generated by the host processor, e.g. CPU, or another processor, of a data processing system.

In embodiments, the ray tracing acceleration data structure comprises a plurality of nodes, with each node of the ray tracing acceleration data structure representing a respective volume of a scene to be rendered, and at least some of the nodes being associated with a set of geometry (e.g. one or more primitives) that falls within the respective volume. In embodiments, the ray tracing acceleration data structure is arranged as a hierarchy of nodes representing a hierarchy of volumes, e.g. and in embodiments, the ray tracing acceleration data structure comprises one or more bounding volume hierarchies (BVHs). In embodiments, the ray tracing acceleration data structure comprises end (e.g. leaf) nodes that are each associated with (represent) a set of geometry (e.g. a set of one or more primitives) defined within the respective volume that the end (e.g. leaf) node corresponds to.

In embodiments, the graphics processor (comprises a ray-volume intersection testing circuit that) is operable to test rays for intersection with volumes that are represented by the nodes of the ray tracing acceleration data structure (e.g. BVH). When a ray is found to intersect a node that is associated with one or more primitives, e.g. when a ray is found to intersect an end (e.g. leaf) node, the ray is tested for intersection with the set of geometry (e.g. one or more primitives) that the (e.g. end/leaf) node corresponds to (by a ray-geometry intersection testing circuit of the graphics processor).

In embodiments, when a ray is found (by the ray-geometry intersection testing circuit) to intersect geometry (e.g. a primitive), one or more “hit” operations are triggered and performed, e.g. to launch one or more secondary rays, perform a colour calculation, etc.. When a ray is not found to intersect any geometry, one or more “miss” operations may be triggered and performed, e.g. to determine a “default”, e.g. background, colour.

Thus, in embodiments, the graphics processor is operable to trace a ray by traversing a ray tracing acceleration data structure and testing the ray against volumes represented by nodes of the ray tracing acceleration data structure to determine whether the ray intersects the volumes, and when it is determined that the ray intersects a volume represented by a node of the ray tracing acceleration data structure that is associated with a set of geometry (e.g. one or more primitives) that falls within the volume that the node represents, testing the ray against the geometry (e.g. one or more primitives) to determine whether the ray intersects the geometry (e.g. one or more primitives), and when it is determined that the ray intersects geometry (e.g. a primitive of the one or more primitives), perform one or more ray hit operations. In embodiments, when it is determined that a ray does not intersect any geometry represented by the ray tracing acceleration data structure, one or more ray miss operations are performed.

Thus, in embodiments, the graphics processor is operable to perform ray tracing by traversing rays through a ray tracing acceleration data structure to determine whether the rays intersect geometry represented by the ray tracing acceleration data structure, and performing one or more ray tracing hit operations in response to determining that a ray intersects geometry represented by the ray tracing acceleration data structure (and performing one or more ray tracing miss operations in response to determining that a ray does not intersect any geometry represented by the ray tracing acceleration data structure).

A ray tracing acceleration data structure could comprise, e.g. a single tree structure (e.g. BVH) representing the entirety of a scene being rendered. In embodiments, a ray tracing acceleration data structure comprises multiple “levels” of tree structures (e.g. BVHs).

For example, in embodiments, the ray tracing acceleration data structure comprises one or more “lowest level” tree structures (e.g. BVHs) (which may also be referred to as a “bottom level acceleration structure (BLAS)”), that each represent a respective instance or object within a scene to be rendered, and a “highest level” tree structure (e.g. BVH) (which may also be referred to as a “top level acceleration structure (TLAS)”) that refers to the one or more “lowest level” tree structures. In this case, each “lowest level” tree structure may comprise end (e.g. leaf) nodes that represent a set of geometry (e.g. one or more primitives) associated with the respective instance or object, and the “highest level” tree structure may comprise end (e.g. leaf) nodes that point to, e.g. the root node of, one or more of the one or more “lowest level” tree structures.

In embodiments, each “lowest level” tree structure (e.g. BLAS) is defined in a space that is associated with the respective instance or object, e.g. a model space, whereas the “highest level” tree structure (e.g. TLAS) is defined in a space that is associated with the entire scene, e.g. a world space. In this case, each “highest level” tree structure end (e.g. leaf) node may include information indicative of an appropriate transformation between respective spaces. Correspondingly, traversal of the ray tracing acceleration data structure may comprise, when an end (e.g. leaf) node of the “highest level” tree structure is reached, applying a transformation indicated by the end (e.g. leaf) node, and then beginning traversal of the corresponding “lowest level” tree structure.

Other arrangements are possible.

In embodiments of the technology described herein, ray tracing-based rendering is triggered and performed by the graphics processor executing a shader program that causes the graphics processor to perform ray tracing rendering processes.

In embodiments, a set of ray tracing shader programs that together define a (at least one) ray tracing pipeline is initially provided (to the apparatus/processing circuit (e.g. compiler)). In embodiments, a shader binding table (SBT) is (also) provided that identifies (all of) the ray tracing shader programs of the set. The shader binding table (SBT) may comprise one or more handles that (each) identify a respective ray tracing shader program of the set.

The set of ray tracing shader programs (e.g. and corresponding shader binding table (SBT)) may be provided in any suitable manner. In embodiments, the set of ray tracing shader programs (e.g. and corresponding shader binding table (SBT)) is provided by an application executing on the host processor (e.g. CPU) that requires graphics processing operations by the graphics processor. Thus, in embodiments, the apparatus/processing circuit (e.g. compiler) receives the set of ray tracing shader programs (e.g. and corresponding shader binding table (SBT)) from an application executing on the host processor (e.g. CPU).

A set of (initially provided) ray tracing shader programs can comprise any suitable ray tracing shader programs that each define a respective element (e.g. some but not all) of a ray tracing pipeline, but can together define a (at least one) (complete) ray tracing pipeline. In embodiments, a (each) ray tracing shader program of the set is initially provided in a high-level shader programming language, such as GLSL, HLSL, OpenCL, etc..

In embodiments, the set of (initially provided) ray tracing shader programs comprises one or more ray generation shader programs, one or more hit shader programs, and one or more miss shader programs. The set of (initially provided) ray tracing shader programs may comprise one or more other types of shader programs, such as one or more “callable shaders”.

A (each) hit shader program may comprise instructions to (when executed by the graphics processor) cause the graphics processor to perform one or more ray hit operations, e.g. as described above. A hit shader program may be, for example, a “closest-hit” shader program, an “any-hit” shader program, or an “intersection” shader program.

A (each) miss shader program may comprise instructions to (when executed by the graphics processor) cause the graphics processor to perform one or more ray miss operations, e.g. as described above.

A (each) ray generation shader program may comprise instructions to (when executed by the graphics processor) cause the graphics processor to generate and begin tracing one or more rays, e.g. by traversing the one or more rays through a (the) ray tracing acceleration data structure, e.g. as described above.

In embodiments, a (each) ray generation shader program (further) comprises one or more instructions (e.g. “calls”) to (when executed by the graphics processor) cause the graphics processor to execute another ray tracing shader program of the set. For example, a ray generation shader program may comprise one or more calls to cause the graphics processor to execute a hit shader program, e.g. in response to determining that a ray intersects geometry. A ray generation shader program may (further) comprise one or more calls to cause the graphics processor to execute a miss shader program, e.g. in response to determining that a ray does not intersect any geometry. Similarly, a shader program may comprise one or more calls to a “callable shader” program.

Thus, in embodiments, one or more (“caller”) ray tracing shader programs of the set of (initially provided) ray tracing shader programs comprise one or more calls that will, when executed by the graphics processor, cause the graphics processor to execute another (“callee”) ray tracing shader program of the set.

Such calls could directly identify a callee ray tracing shader program. However, to allow for flexibility, in embodiments, a call in a (initially provided) caller ray tracing shader program can cause the graphics processor to identify a callee ray tracing shader program using the shader binding table (SBT), and then execute the identified callee ray tracing shader program. This can then allow, for example, the graphics processor to dynamically determine which hit shader program to execute depending on which geometry has been intersected. That is, different hit shader programs (and thus different ray hit operations) may be triggered in response to a ray intersecting different geometry. Similarly, different miss shader programs may be identified and executed in different situations.

Thus, in embodiments, one or more (“caller”) ray tracing shader programs of the set of (initially provided) ray tracing shader programs comprise one or more calls that will, when executed by the graphics processor, cause the graphics processor to (dynamically, during ray tracing) identify another (“callee”) ray tracing shader program of the set (using the shader binding table (SBT)), and execute the identified ray tracing shader program.

Instructions of different (initially provided) ray tracing shader programs can be combined to generate a combined ray tracing shader program in any suitable manner. In embodiments, calls in a caller ray tracing shader program to callee ray tracing shader program(s) are “inlined” into the caller ray tracing shader program (by the generating/processing circuit (e.g. compiler)). That is, in embodiments, calls in a caller ray tracing shader program to callee ray tracing shader program(s) are replaced in the caller ray tracing shader program with instructions comprising instructions of the callee ray tracing shader program(s).

In embodiments, calls in a ray generation shader program to other (e.g. hit and miss) shader programs are “inlined” into the ray generation shader program (by the generating/processing circuit (e.g. compiler)). That is, in embodiments, calls in a ray generation shader program to other (e.g. hit and miss) shader programs are replaced in the ray generation shader program with instructions comprising instructions of the other (e.g. hit and miss) shader programs. Where the set of (initially provided) ray tracing shader programs comprises plural ray generation shader programs, plural corresponding combined ray tracing shader programs may be generated in this manner.

In embodiments, this inlining process involves (the generating/processing circuit (e.g. compiler)) including instructions of different callee ray tracing shader programs in a caller ray tracing shader program together with one or more appropriate control instructions. Thus, in embodiments, generating a combined ray tracing shader program comprises (the generating/processing circuit (e.g. compiler)) including in the combined ray tracing shader program one or more control instructions/statements that will (when executed by the graphics processor) cause the graphics processor to select instructions of a ray tracing shader program included in the combined ray tracing shader program to execute, and execute the selected instructions. Correspondingly, in embodiments, the graphics processor executing the combined ray tracing shader program comprises the graphics processor selecting instructions of a ray tracing shader program included in the combined ray tracing shader program to execute, and executing the selected instructions.

For example, in embodiments, one or more switch statements are added to a caller ray tracing shader program (to generate a combined ray tracing shader program). A (each) switch statement may have one or more cases, wherein a (each) case is associated with (e.g. includes or refers to) instructions of a (respective) callee ray tracing shader program.

Thus, in embodiments, generating a combined ray tracing shader program comprises (the generating/processing circuit (e.g. compiler)) including in the combined shader program one or more switch statements having cases that represent instructions of different ray tracing shader programs. Correspondingly, in embodiments, the graphics processor executing the combined ray tracing shader program comprises the graphics processor selecting one or more cases of one or more switch statements and executing instructions associated with the selected one or more cases.

For example, a switch statement may be added to a ray generation shader program that has cases for instructions of different hit and miss shader programs. Alternatively, a switch statement may be added to a ray generation shader program that has cases for instructions of different hit shader programs, and another switch statement may be added to the ray generation shader program that has cases for instructions of different miss shader programs. Other arrangements are possible.

The shader binding table (SBT) may be used (by the generating/processing circuit (e.g. compiler)) during the inlining process to identify callee ray tracing shader programs (to be inlined). Thus, in embodiments, generating a combined ray tracing shader program comprises (the generating/processing circuit (e.g. compiler)) combining instructions of different ray tracing shader programs using a (the) shader binding table (SBT) that identifies the ray tracing shader programs. In embodiments, one or more callee ray tracing shader programs are identified using the shader binding table (SBT), and one or more calls in a caller ray tracing shader program are replaced with instructions comprising instructions of the one or more identified callee ray tracing shader programs.

In embodiments, a unique identifier is associated (by the generating/processing circuit (e.g. compiler)) with a (each) (callee) ray tracing shader program identified by the shader binding table (SBT), and used as a control variable for the control instructions (e.g. switch statement(s)). The unique identifier may, for example, comprise an index. Thus, in embodiments, unique identifiers (e.g. indexes) are associated with (callee) ray tracing shader programs of the set (identified by the shader binding table (SBT)), and one or more control instructions (e.g. one or more switch statements) are included in the combined ray tracing shader program that will (when executed by the graphics processor) cause the graphics processor to select instructions (of a ray tracing shader program included in the combined ray tracing shader program) to execute using the unique identifiers (e.g. indexes).

In embodiments, the unique identifier (e.g. index) associated with a (each) (callee) ray tracing shader program is stored (by the generating/processing circuit (e.g. compiler)) in the shader binding table (SBT), in embodiments in the handle for the (respective) ray tracing shader program. In embodiments, the unique identifier(s) stored in the shader binding table (SBT) are then dynamically used by the graphics processor (during ray tracing) to select which instructions to execute (e.g. which case of a switch statement to execute).

Thus, in embodiments, a call in a caller ray tracing shader program is replaced with one or more instructions that will, when executed by the graphics processor, cause the graphics processor to use the shader binding table (SBT) to determine a unique identifier (e.g. index), use the unique identifier (e.g. index) as a control variable of control instructions (e.g. a switch statement) to select (e.g. a case of the switch statement associated with) instructions to execute, and execute the selected instructions (e.g. associated with the identified case of the switch statement). Correspondingly, in embodiments, the graphics processor executing the combined ray tracing shader program comprises the graphics processor using the shader binding table (SBT) to determine a unique identifier, using the unique identifier as a control variable of control instructions to select instructions to execute, and executing the selected instructions.

A (the) shader binding table (SBT) may be used to determine a unique identifier in any suitable manner. In embodiments, the shader binding table (SBT) is used in the normal manner for the graphics processor in question, e.g. by looking up a handle in the shader binding table (SBT). For example, in embodiments, one or more offsets may be determined (e.g. in response to and based on a ray being found to intersect geometry) and used to find an appropriate handle in the shader binding table (SBT), and the unique identifier associated with that handle determined.

Other arrangements are possible.

In embodiments described above, the shader binding table (SBT) (comprising unique identifiers) may be used dynamically (during ray tracing) to determine which instructions to execute. The inventors have recognised, however, that it can be the case that the full flexibility provided by the dynamic (during ray tracing) use of a shader binding table (SBT) is not required, and in that in such circumstances further simplifications and optimisations may be possible. For example, where, in response to a ray being found to intersect geometry, the same hit shader program (and thus the same ray hit operation(s)) is triggered, regardless of the geometry that is intersected, inlining may be accomplished in a more straightforward manner (e.g. without including instructions that interrogate the shader binding table (SBT) at runtime to determine which instructions to execute).

In embodiments, the apparatus/processing circuit (e.g. compiler) is configured to attempt to identify such situations, e.g. based on the initially provided set of ray tracing shader programs and shader binding table (SBT).

To do this, in embodiments, the apparatus/processing circuit (e.g. compiler) attempts to use the set of (initially provided) ray tracing shader programs and shader binding table (SBT) to build a “call graph” that indicates which caller ray tracing shader programs of the set call which callee ray tracing shader programs of the set. In embodiments, if the apparatus/processing circuit (e.g. compiler) is successful in building a complete call graph, it may be determined that dynamic use of the shader binding table (SBT) will not be required (at runtime). In embodiments, one or more calls in a caller ray tracing shader program are then replaced (by the apparatus/processing circuit (e.g. compiler)) with instructions comprising one or more control instructions corresponding to and based on the structure of the call graph.

Thus, in embodiments, generating the combined ray tracing shader program comprises: (the generating/processing circuit (e.g. compiler)) building a call graph that indicates which ray tracing shader programs of the set call which other ray tracing shader programs of the set, and combining instructions of different ray tracing shader programs of the set based on the call graph.

In embodiments, once instructions of different ray tracing shader programs have been combined to generate a combined ray tracing shader program, the combined ray tracing shader program is subjected to one or more compiler optimisation operations. Thus, in embodiments, the providing/processing circuit is or comprises an optimising compiler which performs one or more compiler optimisation operations on the combined ray tracing shader program.

In embodiments described above, the apparatus/processing circuit (e.g. compiler) may attempt to determine at compile time whether a combined ray tracing shader program can be generated that will not need to use a shader binding table (SBT) dynamically at runtime. The inventors have found, however, that it can sometimes not be possible for the apparatus/processing circuit (e.g. compiler) to conclusively determine at compile time whether a shader binding table (SBT) will be used dynamically at runtime. However, the inventors have recognised that it can be possible to define at compile time one or more conditions that, if met at runtime, will indicate that a shader binding table (SBT) is not being used dynamically at runtime.

Thus, in embodiments, the apparatus/processing circuit (e.g. compiler) generates/compiles the combined ray tracing shader program based on an assumption that one or more conditions will be met at runtime. In embodiments, the one or more conditions are such that they will be met if ray tracing can be performed without dynamically using a shader binding table (SBT). For example, and in embodiments, the one or more conditions are such that they will be met if which hit shader to execute in response to a ray being found to intersect geometry does not depend on which geometry is intersected.

In embodiments, one or more check instructions are then included in the combined ray tracing shader program (by the generating/processing circuit (e.g. compiler)) to (when executed by the graphics processor) cause the graphics processor to check whether the one or more conditions (actually) are met (at runtime). In embodiments, when it is determined (at runtime) that the one or more conditions are met, execution of the combined ray tracing shader program (that has been generated/compiled based on the assumption that the one or more conditions are met) may continue. In embodiments, when it is not determined (at runtime) that the one or more conditions are met (when it is determined (at runtime) that the one or more conditions are not met), execution of the combined ray tracing shader program may be discontinued. For example, execution of separately compiled ray tracing shader programs (e.g. as described above) may be triggered. Other arrangements are possible.

Thus, in embodiments, one or more ray tracing shader programs of the set of (initially provided) ray tracing shader programs comprise one or more calls that will, when executed by the graphics processor, cause the graphics processor to execute another ray tracing shader program of the set; generating the combined ray tracing shader program comprises (the generating/processing circuit (e.g. compiler)) combining instructions such that the combined ray tracing shader program will, when executed by the graphics processor, cause the graphics processor to implement a (e.g. complete) ray tracing pipeline without executing any other (executable) ray tracing shader program provided one or more conditions are met; and one or more (check) instructions are included in the combined ray tracing shader program (by the generating/processing circuit (e.g. compiler)) that will, when executed by the graphics processor, cause the graphics processor to determine whether the one or more conditions are met.

In embodiments, the one or more (check) instructions will, when executed by the graphics processor, cause the graphics processor to: when it is determined that the one or more conditions are met, (continue to) implement the (e.g. complete) ray tracing pipeline without executing any other (executable) ray tracing shader program. Correspondingly, in embodiments, the graphics processor executing the combined ray tracing shader program comprises the graphics processor: executing the one or more (check) instructions to determine whether the one or more conditions are met; and when it is determined that the one or more conditions are met, implementing the (e.g. complete) ray tracing pipeline without executing any other (executable) ray tracing shader program.

The one or more check instructions can cause the graphics processor to check whether the one or more conditions are met in any suitable manner. In embodiments, whether a shader binding table (SBT) will be used dynamically at runtime may be determined from a configuration of a ray tracing acceleration data structure. Thus, in embodiments, the one or more check instructions (when executed by the graphics processor) cause the graphics processor to determine whether the one or more conditions are met based on a configuration of a ray tracing acceleration data structure (that rays are to be traversed through).

Thus, in embodiments, the one or more (check) instructions, when executed by the graphics processor, cause the graphics processor to determine whether the one or more conditions are met based on one or more properties of a ray tracing acceleration data structure.

In embodiments, information indicating whether the one or more conditions are met is stored in association with a ray tracing acceleration data structure, and the one or more check instructions (when executed by the graphics processor) cause the graphics processor to (read the information and) use the information to determine whether the one or more conditions are met. The information may comprise metadata, e.g. comprising one or more flags indicating whether or not the one or more conditions are met.

Information (metadata) indicating whether the one or more conditions are met may be generated and stored in association with a ray tracing acceleration data structure in any suitable manner. In embodiments, the information is generated and stored in association with a ray tracing acceleration data structure when building the ray tracing acceleration data structure. The driver for the graphics processor (that is executing on the host processor (CPU)) may be operable to build ray tracing acceleration data structures for traversal by the graphics processor, and so may (also) generate and store the information.

Thus, in embodiments, a ray tracing acceleration data structure is built for traversal by the graphics processor (by the apparatus/processing circuit); it is determined (by the apparatus/processing circuit), based on one or more properties of the ray tracing acceleration data structure, whether the one or more conditions are met; and information (metadata) indicating whether the one or more conditions are determined to be met is stored (by the apparatus/processing circuit) in association with the ray tracing acceleration data structure. Correspondingly, in embodiments, the graphics processor executing the combined ray tracing shader program comprises the graphics processor (executing the one or more check instructions to) determining whether the one or more conditions are met using the information (metadata) stored in association with the ray tracing acceleration data structure.

Thus, embodiments comprise (the apparatus/processing circuit):
building a ray tracing acceleration data structure for traversal by the graphics processor;
determining whether one or more conditions are met based on one or more properties of the ray tracing acceleration data structure;
storing, in association with the ray tracing acceleration data structure, information (metadata) indicating whether the one or more conditions are met; and
providing the ray tracing acceleration data structure for traversal by the graphics processor;
and further:
generating, from a set of ray tracing shader programs that define different elements of a ray tracing pipeline, a combined ray tracing shader program by combining instructions of different ray tracing shader programs of the set;
including in the combined ray tracing shader program one or more instructions that will, when executed by the graphics processor, cause the graphics processor to use the information (metadata) to determine whether the one or more conditions are met; and
providing the combined ray tracing shader program for execution by the graphics processor;
and further (the graphics processor):
executing the combined ray tracing shader program;
using the information (metadata) stored in association with the ray tracing acceleration data structure to determine whether the one or more conditions are met; and
when it is determined that the one or more conditions are met:
continuing execution of the combined ray tracing shader program; and
traversing rays through the ray tracing acceleration data structure.

It may be determined, based on one or more properties of a ray tracing acceleration data structure, whether the one or more conditions are met in any suitable and desired manner. In embodiments, it is determined (by the apparatus/processing circuit) whether the ray tracing acceleration data structure is configured such that a (type of) ray tracing hit operation performed by the graphics processor in response to a ray being determined to intersect geometry represented by the ray tracing acceleration data structure may depend on the geometry that is intersected, and it is determined that the one or more conditions are met when it is not determined that the ray tracing acceleration data structure is configured such that a (type of) ray tracing hit operation performed by the graphics processor in response to a ray being determined to intersect geometry represented by the ray tracing acceleration data structure may depend on the geometry that is intersected (when it is determined that the ray tracing acceleration data structure is configured such that a (type of) ray tracing hit operation performed by the graphics processor in response to a ray being determined to intersect geometry represented by the ray tracing acceleration data structure will not depend on the geometry that is intersected).

In embodiments, building a ray tracing acceleration data structure involves determining information identifying one or more instances and/or one or more objects and/or one or more sets of geometry, e.g. comprising one or more identifiers and/or offset values. In embodiments, this information is used to determine whether the ray tracing acceleration data structure is configured such that a ray tracing hit operation performed by the graphics processor in response to a ray being determined to intersect geometry represented by the ray tracing acceleration data structure may depend on the geometry that is intersected. For example, if all geometry represented by the ray tracing acceleration data structure is associated with the same identifier, it may be determined that the same (type of) hit operation(s) will be performed (corresponding to the same hit shader program) for all geometry (and so a ray tracing hit operation performed by the graphics processor in response to a ray being determined to intersect geometry represented by the ray tracing acceleration data structure will not depend on the geometry that is intersected). Other arrangements are possible.

Another embodiment of the technology described herein comprises a method of providing a ray tracing acceleration data structure for traversal by a graphics processor that is operable to perform ray tracing by traversing rays through a ray tracing acceleration data structure to determine whether the rays intersect geometry represented by the ray tracing acceleration data structure, and performing one or more ray tracing hit operations in response to determining that a ray intersects geometry represented by the ray tracing acceleration data structure; the method comprising:
building a ray tracing acceleration data structure for traversal by the graphics processor;
determining whether the ray tracing acceleration data structure is configured such that a (type of) ray tracing hit operation performed by the graphics processor in response to a ray being determined to intersect geometry represented by the ray tracing acceleration data structure may depend on the geometry that is intersected; and
storing, in association with the ray tracing acceleration data structure, information indicating whether the ray tracing acceleration data structure is determined to be configured such that a (type of) ray tracing hit operation performed by the graphics processor in response to a ray being determined to intersect geometry represented by the ray tracing acceleration data structure may depend on the geometry that is intersected.

Another embodiment of the technology described herein comprises an apparatus for providing a ray tracing acceleration data structure for traversal by a graphics processor that is operable to perform ray tracing by traversing rays through a ray tracing acceleration data structure to determine whether the rays intersect geometry represented by the ray tracing acceleration data structure, and performing one or more ray tracing hit operations in response to determining that a ray intersects geometry represented by the ray tracing acceleration data structure; the apparatus comprising:
a building circuit configured to build a ray tracing acceleration data structure for traversal by the graphics processor; and
a processing circuit configured to:
determine whether a ray tracing acceleration data structure built by the building circuit is configured such that a (type of) ray tracing hit operation performed by the graphics processor in response to a ray being determined to intersect geometry represented by the ray tracing acceleration data structure may depend on the geometry that is intersected; and
store, in association with the ray tracing acceleration data structure, information indicating whether the ray tracing acceleration data structure is determined to be configured such that a (type of) ray tracing hit operation performed by the graphics processor in response to a ray being determined to intersect geometry represented by the ray tracing acceleration data structure may depend on the geometry that is intersected.

These embodiments can, and in embodiments do, include any one or more or all of the optional features described herein, as appropriate. For example, the apparatus may be a host processor (e.g. CPU) of a graphics processing system that also comprises the graphics processor. The apparatus (e.g. CPU) may be the same apparatus (e.g. CPU) that provides (e.g. compiles) a combined ray tracing shader program, or a different apparatus (e.g. CPU) to the apparatus (e.g. CPU) that provides (e.g. compiles) a combined ray tracing shader program.

In embodiments, the information comprises a flag (e.g. a bit) that indicates whether or not the ray tracing acceleration data structure is determined to be configured such that a (type of) ray tracing hit operation performed by the graphics processor in response to a ray being determined to intersect geometry represented by the ray tracing acceleration data structure may depend on the geometry that is intersected (e.g. a flag (e.g. a bit) that indicates whether or not a determination of which (hit) shader program (instructions) to execute may need to be made in response to a ray being determined to intersect geometry).

In embodiments, the flag (e.g. bit) can take either a first value (e.g. 0) or a second value (e.g. 1), wherein the first value (e.g. 0) indicates that the ray tracing acceleration data structure is determined to be configured such that a (type of) ray tracing hit operation performed by the graphics processor in response to a ray being determined to intersect geometry represented by the ray tracing acceleration data structure can depend on the geometry that is intersected, and the second value (e.g. 1) indicates that the ray tracing acceleration data structure is not determined to be configured such that a (type of) ray tracing hit operation performed by the graphics processor in response to a ray being determined to intersect geometry represented by the ray tracing acceleration data structure may depend on the geometry that is intersected (the ray tracing acceleration data structure is determined to be configured such that a (type of) ray tracing hit operation performed by the graphics processor in response to a ray being determined to intersect geometry represented by the ray tracing acceleration data structure will not depend on the geometry that is intersected).

In the case of a ray tracing acceleration data structure that comprises multiple “levels” of tree structures, information (e.g. a flag) could be generated and stored in respect of each tree structure and/or level (e.g. each BLAS/TLAS). Thus, the information may comprise plural different indications (e.g. flags). Alternatively, information (e.g. a flag) may be generated and stored (e.g. only) in respect of the entirety of the ray tracing acceleration data structure. Thus, the information may be stored in association with a higher level acceleration data structure (e.g. TLAS).

In embodiments, the information (e.g. flag) is stored together with the ray tracing acceleration data structure, e.g. in (main) memory, for subsequent use by the graphics processor. The information (e.g. flag) may, for example, be stored in metadata for the ray tracing acceleration data structure, e.g. in a header, or another suitable data structure.

Further embodiments comprise a graphics processor traversing a ray tracing acceleration data structure provided as above.

Another embodiment comprises a method of operating a graphics processing system comprising a graphics processor that is operable to perform ray tracing; the method comprising:
the graphics processor executing a combined ray tracing shader program provided according to a method described above; and/or
the graphics processor traversing a ray tracing acceleration data structure provided according to a method described above.

Another embodiment comprises a graphics processing system comprising:
a graphics processor operable to perform ray tracing; and
an apparatus for providing ray tracing shader programs as described above, wherein the graphics processor is configured to execute a combined ray tracing shader program provided by the apparatus; and/or
an apparatus for providing a ray tracing acceleration data structure as described above, wherein the graphics processor is configured to traverse a ray tracing acceleration data structure provided by the apparatus.

These embodiments can, and in embodiments do, include any one or more or all of the optional features described herein, as appropriate. For example, the apparatus for providing ray tracing shader programs may be the same apparatus as the apparatus for providing a ray tracing acceleration data structure, or a different apparatus.

Each embodiment of the technology described herein can, and in embodiments does, include one or more, and in embodiments all, features of other embodiments of the technology described herein, as appropriate.

The technology described herein can be implemented in any suitable system, such as a suitably configured micro-processor based system. In embodiments, the technology described herein is implemented in a computer and/or micro-processor based system. The technology described herein is in embodiments implemented in a portable device, such as, and in embodiments, a mobile phone or tablet.

The technology described herein is applicable to any suitable form or configuration of graphics processor and graphics processing system, such as graphics processors (and systems) having a “pipelined” arrangement (in which case the graphics processor executes a rendering pipeline).

In embodiments, the various functions of the technology described herein are carried out on a single data processing platform that generates and outputs data, for example for a display device.

As will be appreciated by those skilled in the art, the data/graphics processing system may include, e.g., and in embodiments, a host processor that, e.g., executes applications that require processing by the graphics processor. The host processor will send appropriate commands and data to the graphics processor to control it to perform graphics processing operations and to produce graphics processing output required by applications executing on the host processor. To facilitate this, the host processor should, and in embodiments does, also execute a driver for the processor and optionally a compiler or compilers for compiling (e.g. shader) programs to be executed by (e.g. an (programmable) execution unit of) the processor.

The graphics processor and/or graphics processing system may also comprise, and/or be in communication with, one or more memories and/or memory devices that store the data described herein, and/or store software (e.g. (shader) program) for performing the processes described herein. The processor and/or system may also be in communication with and/or include a host microprocessor, and/or with a display for displaying images based on data generated by the processor/system.

The technology described herein can be used for all forms of input and/or output that a graphics processor may use or generate. For example, the graphics processor may execute a graphics processing pipeline that generates frames for display, render-to-texture outputs, etc.. The output data values from the processing are in embodiments exported to external, e.g. main, memory, for storage and use, such as to a frame buffer for a display.

The various functions of the technology described herein can be carried out in any desired and suitable manner. For example, the functions of the technology described herein can be implemented in hardware or software, as desired. Thus, for example, the various functional elements, stages, and “means” of the technology described herein may comprise a suitable processor or processors, controller or controllers, functional units, circuitry, circuit(s), processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuitry/circuits, e.g., in the form of one or more fixed-function units (hardware) (processing circuitry/circuits), and/or in the form of programmable processing circuitry/circuits that can be programmed to perform the desired operation. Equally, any one or more of the processing stages and processing stage circuitry/circuits of the technology described herein may be provided as a separate circuit element to any one or more of the other processing stages or processing stage circuitry/circuits, and/or any one or more or all of the processing stages and processing stage circuitry/circuits may be at least partially formed of shared processing circuitry/circuits.

Subject to any hardware necessary to carry out the specific functions discussed above, the components of the graphics processing system can otherwise include any one or more or all of the usual functional units, etc., that such components include.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc..

The technology described herein also extends to a computer software carrier comprising such software which when used to operate a data processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

Embodiments of the technology described herein will now be described with reference to the drawings.

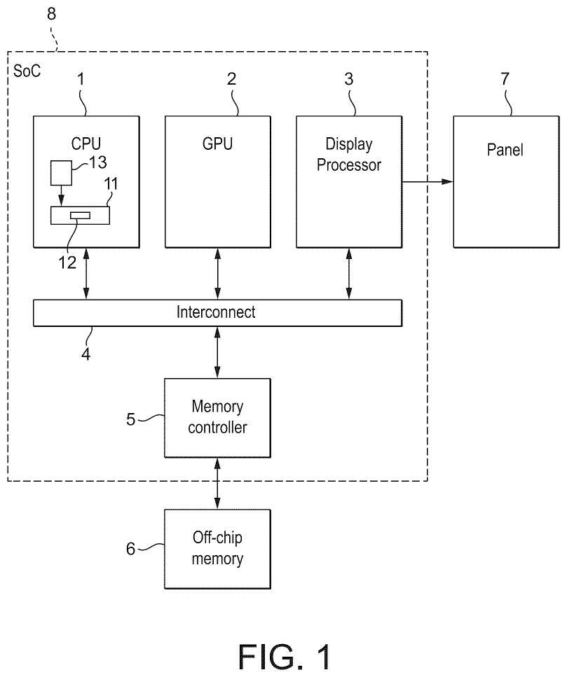

FIG. 1 shows an exemplary system on-chip (SoC) graphics processing system 8 that comprises a host processor in the form of a central processing unit (CPU) 1, a graphics processor (GPU) 2, a display processor 3 and a memory controller 5. As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 13 such as a game, executing on the host processor (CPU) 1 will, for example, require the display of frames on the display panel 7. To do this, the application 13 will submit appropriate commands and data to a driver 11 for the graphics processor 2 that is executing on the CPU 1. As will be discussed in more detail below, this may include the application 13 submitting shader programs to the driver 11 that are to be executed by the graphics processor 2.

The driver 11 will then generate appropriate commands and data to cause the graphics processor 2 to render appropriate frames for display and to store those frames in appropriate frame buffers, e.g. in the main memory 6. This may include compiler 12 compiling any shader program instructions provided by the application 13, and the graphics processor 2 executing the compiled shader program instructions. The display processor 3 will then read the frames generated by the graphics processor 2 into a buffer for the display from where they are then read out and displayed on the display panel 7 of the display.

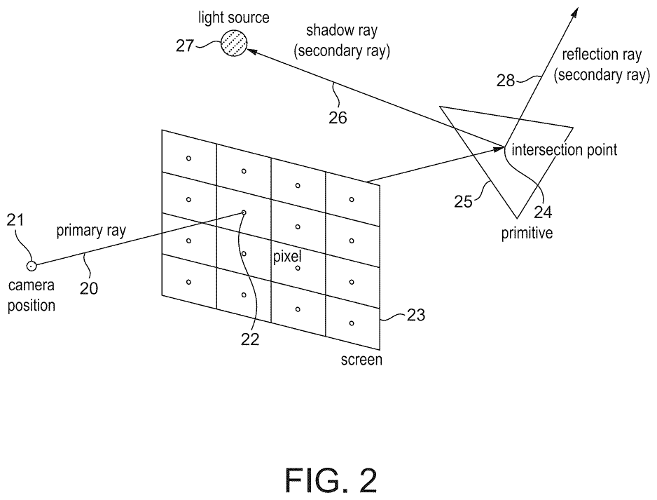

In embodiments of the technology described herein, the graphics processor 2 renders frames for display using a ray tracing process. FIG. 2 illustrates an exemplary ray tracing process that the graphics processor 2 may use to render a frame for display in embodiments of the technology described herein.

As illustrated in FIG. 2, a ray 20 (the “primary ray”) is cast backward from a viewpoint 21 (e.g. camera position) through a sampling position 22 in an image plane (frame) 23 into the scene that is being rendered. The point 24 at which the ray 20 first intersects an object in the scene is identified. This first intersection will be with the object in the scene closest to the sampling position. In this example, the first intersected object is represented by a set (e.g. mesh) of triangle primitives, and the ray 20 is found to intersect a triangle primitive 25 representing the object.

A secondary ray in the form of shadow ray 26 may be cast from the first intersection point 24 to a light source 27. Depending upon the material of the surface of the object, another secondary ray in the form of reflected ray 28 may be traced from the intersection point 24. If the object is, at least to some degree, transparent, then a refracted secondary ray may be considered.

Such casting of secondary rays may be used where it is desired to add shadows and reflections into the image. A secondary ray may be cast in the direction of each light source (and, depending upon whether or not the light source is a point source, more than one secondary ray may be cast back to a point on the light source).

In the example shown in FIG. 2, only a single bounce of the primary ray 20 is considered, before tracing the reflected ray back to the light source. However, a higher number of bounces may be considered if desired.

The output data for the sampling position 22, i.e. a colour value (e.g. RGB value) thereof, is then determined taking into account the interactions of the primary, and any secondary, ray(s) cast, with objects in the scene. The same process is conducted in respect of each sampling position to be considered in the image plane (frame) 23.

Different types of rays may be traced, depending on the scene, etc.. Primary, reflection and refraction rays may be referred to as “closest-hit rays”, since they are typically traced until intersecting geometry closest to the ray's origin is found (or until it is determined that the ray does not intersect any geometry). On the other hand, shadow rays may be referred to as “first-hit rays” or “visibility rays”, as they can typically be terminated as soon as they are found to intersect any geometry (or until it is determined that the ray does not intersect any geometry).

Other forms of ray tracing, such as hybrid rasterization ray tracing, are possible.

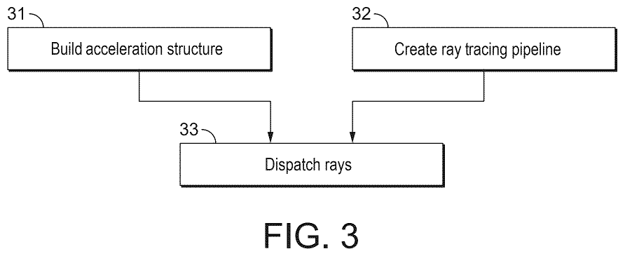

FIG. 3 shows an overview of a process by which the graphics processing system 8 may render a scene using ray tracing in embodiments of the technology described herein. As illustrated in FIG. 3, the driver 11 may build an acceleration data structure that represents geometry in a scene to be rendered (at step 31), and create a ray tracing pipeline that specifies how rays are to be traced through the scene (at step 32). The driver 11 may then then trigger the graphics processor 2 to trace rays through the scene by using the ray tracing pipeline and traversing the acceleration data structure (at step 33). In this process, the acceleration data structure may be updated independently of the ray tracing pipeline, e.g. to account for moving geometry of a dynamic scene.

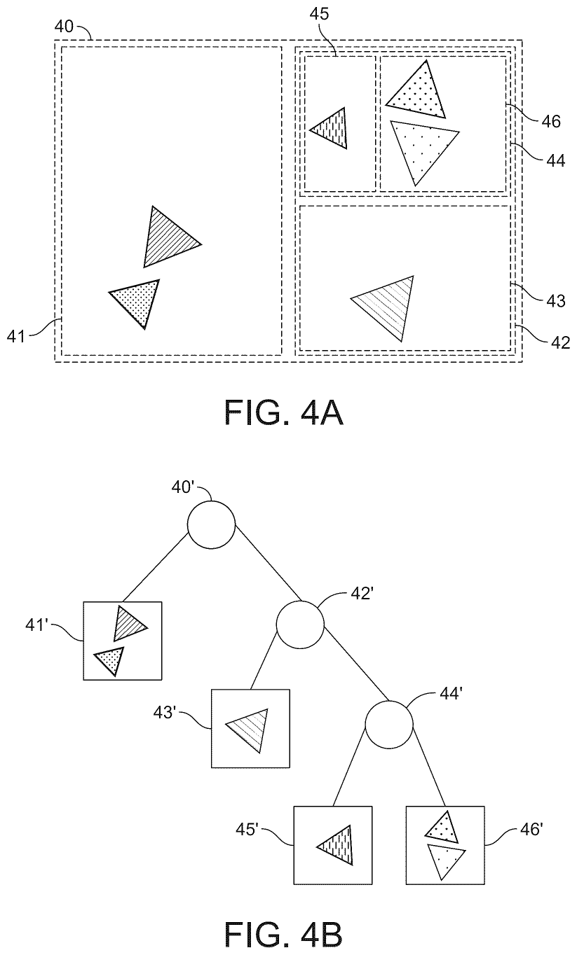

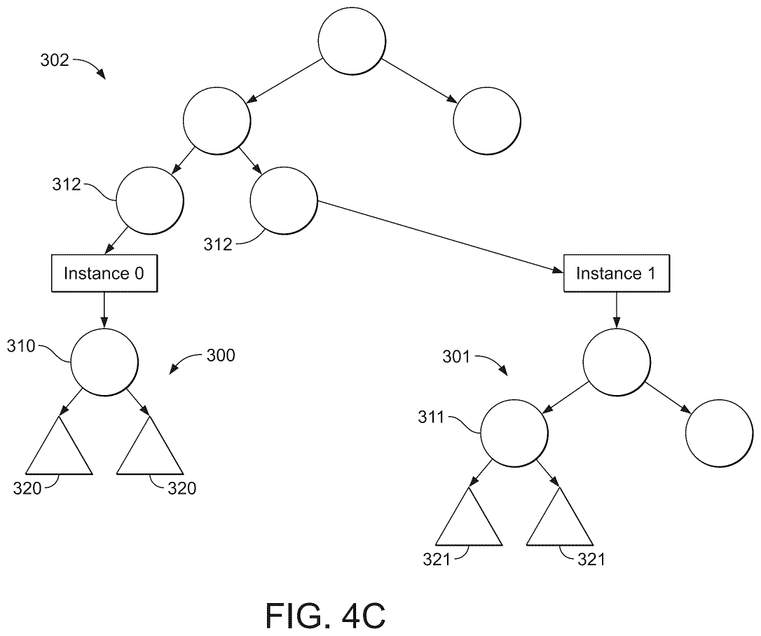

FIG. 4 illustrates exemplary acceleration data structures that may be built by the driver 11 (at step 31) and traversed by graphics processor 2 (at step 33). In the present embodiments, acceleration data structures indicative of the geometry (e.g. objects) in scenes to be rendered are used when determining the intersection data for the ray(s) associated with a sampling position in the image plane to identify a subset of the geometry which a ray may intersect.

A ray tracing acceleration data structure represents and indicates the distribution of geometry (e.g. objects) in the scene being rendered, and in particular the geometry that falls within respective (sub-)volumes in the overall volume of the scene (that is being considered).

In the present embodiments, a ray tracing acceleration data structure is in the form of one or more Bounding Volume Hierarchy (BVH) trees. The use of BVH trees allows and facilitates testing a ray against a hierarchy of bounding volumes until a leaf node is found. It is then only necessary to test the geometry associated with the particular leaf node for intersection with the ray.

FIGS. 4A and 4B illustrate an exemplary BVH tree, constructed by enclosing a volume in an axis-aligned bounding volume (AABV), e.g. a cube, and then recursively sub-dividing the bounding volume into successive sub-AABVs according to any suitable and desired sub-division scheme, e.g. until a desired smallest sub-division (volume) is reached.

In particular, FIG. 4A shows a largest AABV 40 that encloses geometry of a scene. This largest AABV 40 is sub-divided into two smaller sub-AABVs 41, 42 that each enclose only some of the geometry of the scene. Sub-AABV 42 is then sub-divided into two even smaller sub-AABVs 43, 44, and sub-AABV 44 is sub-divided into two even smaller sub-AABVs 45, 46.

In this example, each AABV can be sub-divided into two sub-AABVs, and recursive sub-division is performed until AABVs that contain a maximum of two primitives are obtained. However, in general, any other suitable tree structure may be used, and an AABV may be sub-divided into any suitable and desired number of sub-AABVs.

FIG. 4B illustrates a BVH tree structure corresponding to the sub-divided scene of FIG. 4A. As illustrated in FIG. 4B, the BVH tree is arranged as a hierarchy of nodes, with each node in the BVH tree having a respective AABV associated with it. Each leaf node 41′, 43′, 45′, 46′ of the BVH tree represents a set of (one or two) triangle primitives that fall within the respective AABV that the respective leaf node is associated with. Each parent node 40′, 42′, 44′ represents, and is associated with, the volume of its child nodes.

A complete scene may be represented by a single BVH tree, e.g. with the tree storing the geometry for the scene, e.g. in world space. In this case, each leaf node of the BVH tree may be associated with the geometry defined for the scene that falls, at least in part, within the volume that the leaf node corresponds to (e.g. whose centroid falls within the volume in question). The leaf nodes may represent unique (non-overlapping) subsets of primitives defined for the scene falling within the corresponding volumes for the leaf nodes.

In the present embodiments, a two-level ray tracing acceleration data structure is used. FIG. 4C shows an exemplary two-level ray tracing acceleration data structure in which each instance or object is associated with a respective bottom-level acceleration structure (BLAS) 300, 301, which in the present embodiments is in the form of a respective BVH tree that stores geometry in a model space, with each leaf node 310, 311 of the BVH tree representing a unique subset of primitives 320, 321 defined for the instance or object falling within the corresponding volume. Each BLAS may be associated with a respective instance ID that identifies the instance or object associated with the BLAS, and each subset of primitives may be associated with a geometry ID that can indicate a material that the primitives represent.

A separate top-level acceleration structure (TLAS) 302 then contains references to the set of bottom-level acceleration structures (BLAS), together with a respective set of shading and transformation information for each bottom-level acceleration structure (BLAS). In the present embodiments, the top-level acceleration structure (TLAS) 302 is defined in a “top-level” space (e.g. world space) and is in the form of a BVH tree having leaf nodes 312 that each point to one or more of the bottom-level acceleration structures (BLAS) 300, 301.

Although FIG. 4 illustrates leaf nodes that are associated with geometry that is in the form of a set of (triangle) primitives, others forms of geometry are possible. In embodiments, geometry associated with a leaf node can be in the form of a set (e.g. mesh) of triangle primitives or an axis aligned bounding box (AABB) primitive that indicates a volume within which a procedural object is defined (i.e. an object that is defined by execution of a procedure (program instructions)).

Other forms of geometry and ray tracing acceleration data structures are possible.

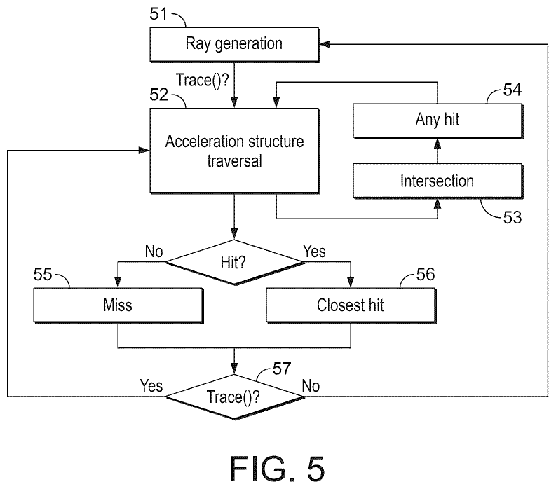

FIG. 5 illustrates an exemplary ray tracing pipeline that may be created by the driver 11 (at step 32) and used by graphics processor 2 (at step 33). As illustrated in FIG. 5, the ray tracing pipeline generates a set of one or more rays to be traced (at step 51), and then traverses the one or more rays through the acceleration data structure (at step 52).

When a ray is found to intersect a (BLAS) leaf node bounding volume (AABV), the ray is tested for intersection with the geometry (e.g. primitives) encompassed by the bounding volume (at step 53). When a ray is found to intersect geometry (e.g. a primitive), transparency information associated with the intersected geometry may be used to determine whether or not the intersection should be ignored (at step 54).

Once traversal of a ray is complete, if no intersecting geometry has been found, a “default” operation may be performed (at step 55). The default operation may comprise, e.g., returning a default (background) colour in the case of a primary ray, or indicating no intersecting geometry in the case of a visibility ray.

Otherwise, if intersecting geometry is found, one or more appropriate further operations may be triggered (at step 56). These one or more further operations may comprise, e.g., launching one or more secondary rays, performing a colour calculation, etc.. This may be based, e.g., on the nature of the geometry (e.g. its surface properties) that the ray has been found to intersect, and the complexity of the ray tracing process being used.

If there are more rays to be traced (at step 57), the process may return to acceleration structure traversal (at step 52), or otherwise a new set of one or more rays to be traced may be generated (at step 51).

This process may be performed for each sampling position to be considered in the image plane (frame). Once the final output value for the sampling position in question has been generated, the processing in respect of that sampling position is completed. A next sampling position may then be processed in a similar manner, and so on, until all the sampling positions for the frame have been appropriately shaded. The frame may then be output, e.g. for display, and the next frame to be rendered processed in a similar manner, and so on.

Other forms of ray tracing pipeline are possible.

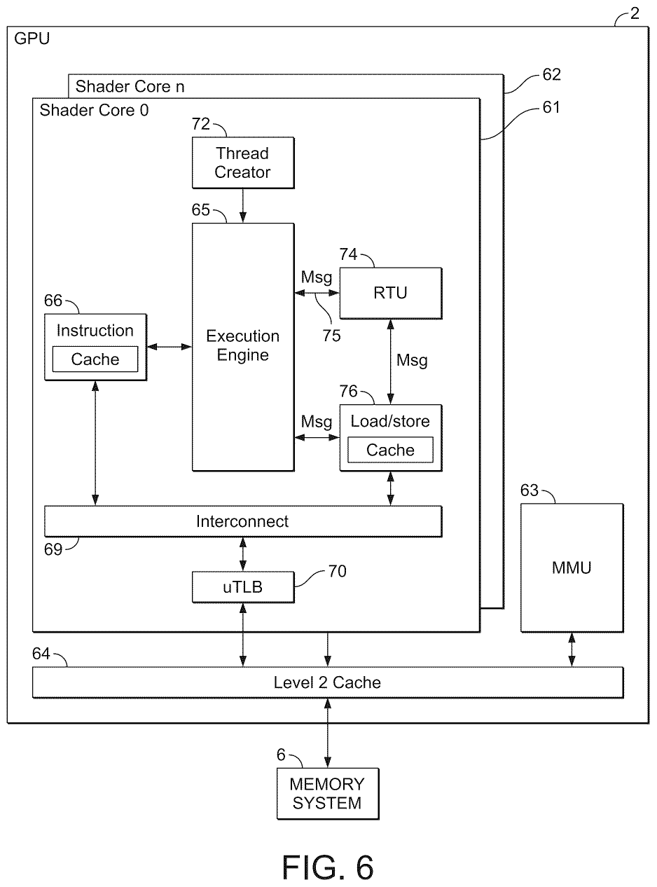

FIG. 6 shows schematically the relevant elements and components of a graphics processor (GPU) 2 of the present embodiments.

FIG. 6 shows the main elements of the graphics processor 2 that are relevant to the operation of the present embodiments. As will be appreciated by those skilled in the art there may be other elements of the graphics processor 2 that are not illustrated in FIG. 6. It should also be noted here that FIG. 6 is only schematic, and that, for example, in practice the shown functional units may share significant hardware circuits, even though they are shown schematically as separate units in FIG. 6. It will also be appreciated that each of the elements and units, etc., of the graphics processor as shown in FIG. 6 may, unless otherwise indicated, be implemented as desired and will accordingly comprise, e.g., appropriate circuits (processing logic), etc., for performing the necessary operation and functions.

As shown in FIG. 6, the GPU 2 includes one or more shader (processing) cores 61, 62, together with a memory management unit (“MMU”) 63 and a level 2 cache 64 which is operable to communicate with an off-chip memory system 6 (e.g. via an appropriate interconnect and (dynamic) memory controller).

FIG. 6 shows schematically the relevant configuration of one shader core 61, but as will be appreciated by those skilled in the art, any further shader cores of the graphics processor 2 will be configured in a corresponding manner.

The graphics processor (GPU) shader cores 61, 62 are programmable processing units (circuits) that perform processing operations by running small programs for each “item” in an output to be generated such as a render target, e.g. frame. An “item” in this regard may be, e.g. a vertex, one or more sampling positions, etc.. The shader cores will process each “item” by means of one or more execution threads which will execute the instructions of the shader program(s) in question for the “item” in question. Typically, there will be multiple execution threads each executing at the same time (in parallel).

As shown in FIG. 6, each shader core of the graphics processor 2 includes an appropriate programmable execution unit (execution engine) 65 that is operable to execute graphics shader programs for execution threads to perform graphics processing operations.

The shader core 61 also includes an instruction cache 66 that stores instructions to be executed by the programmable execution unit 65 to perform graphics processing operations. The instructions to be executed will, as shown in FIG. 6, be fetched from the memory system 6 via an interconnect 69 and a micro-TLB (translation lookaside buffer) 70.

The shader core 61 also includes an appropriate load/store unit 76 in communication with the programmable execution unit 65, that is operable, e.g., to load into an appropriate cache, data, etc., to be processed by the programmable execution unit 65, and to write data back to the memory system 6 (for data loads and stores for programs executed in the programmable execution unit). Again, such data will be fetched/stored by the load/store unit 76 via the interconnect 69 and the micro-TLB 70.

In order to perform graphics processing operations, the programmable execution unit 65 will execute graphics shader programs (sequences of instructions) for respective execution threads (e.g. corresponding to respective sampling positions of a frame to be rendered). Accordingly, as shown in FIG. 6, the shader core 61 further comprises a thread creator (generator) 72 operable to generate execution threads for execution by the programmable execution unit 65.

As shown in FIG. 6, the shader core 61 in this embodiment also includes a ray tracing circuit (unit) (“RTU”) 74, which is in communication with the programmable execution unit 65, and which is operable to perform the required ray-volume (AABV) testing during the ray tracing acceleration data structure traversals (i.e. at step 52 of FIG. 5) for rays being processed as part of a ray tracing-based rendering process, in response to messages 75 received from the programmable execution unit 65.

In the present embodiments the RTU 74 is also operable to perform any required ray-triangle testing (i.e. at step 53 of FIG. 5). The RTU 74 is also able to communicate with the load/store unit 76 for loading in the required data for such intersection testing.

In the present embodiments, the RTU 74 of the graphics processor is a (substantially) fixed-function hardware unit (circuit) that is configured to perform the required ray-volume and ray-triangle intersection testing during a traversal of a ray tracing acceleration data structure to determine geometry for a scene to be rendered that may be (and is) intersected by a ray being used for a ray tracing operation. However, some amount of configurability may be provided.

Other arrangements are possible. For example, ray-volume and/or ray-triangle intersection testing may be performed by the programmable execution unit 65 (e.g. in software).

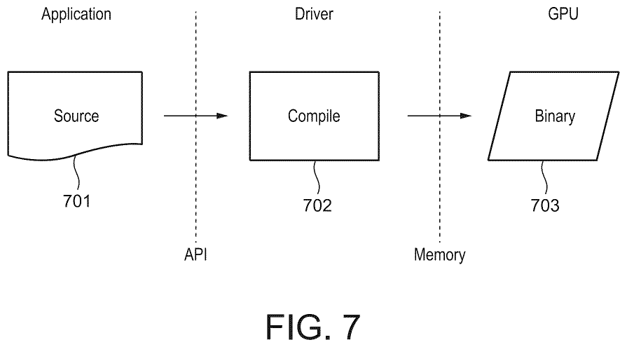

In the present embodiments, shader programs that the graphics processor 2 executes can be initially provided by application 13, compiled by compiler 12 and then provided in compiled form to the graphics processor 2 by the driver 11 as part of ray tracing pipeline creation (i.e. at step 32 of FIG. 3). This is illustrated by FIG. 7. As shown in FIG. 7, the application 13 provides a shader program 701 implemented using a high-level shader programming language, such as GLSL, HLSL, OpenCL, etc., and the shader program 701 is compiled 702 by compiler 12 to binary code 703 for execution by the graphics processor 2.

In the present embodiments, an application 13 provides one or more “ray generation shaders” that the graphics processor 2 should execute in order to generate a set of one or more rays to be traced (i.e. at step 51 of FIG. 5). Different ray generation shaders may be provided e.g. for different rendering modes.

The application 13 also provides one or more “miss shaders” that the graphics processor 2 should execute in order to perform a “default” operation (i.e. at step 55 of FIG. 5). Different miss shaders may be provided e.g. for different ray types. For example, a first miss shader may be provided to return a default colour in the case of a primary ray, and a second miss shader may be provided to indicate no intersecting geometry in the case of a visibility ray.

The application 13 also provides one or more “hit shaders”, including one or more “closest-hit shaders” that the graphics processor 2 should execute in order to perform one or more further operations (i.e. at step 56 of FIG. 5), optionally one or more “any-hit shaders” that the graphics processor 2 should execute in order to determine whether an intersection should be ignored (i.e. at step 54 of FIG. 5), and optionally one or more “intersection shaders” that the graphics processor 2 should execute in order to determine whether a ray intersects a procedural object defined by the shader (i.e. at step 53 of FIG. 5). Different hit shaders may be provided for e.g. different ray types, different instances, different materials/geometries, etc..

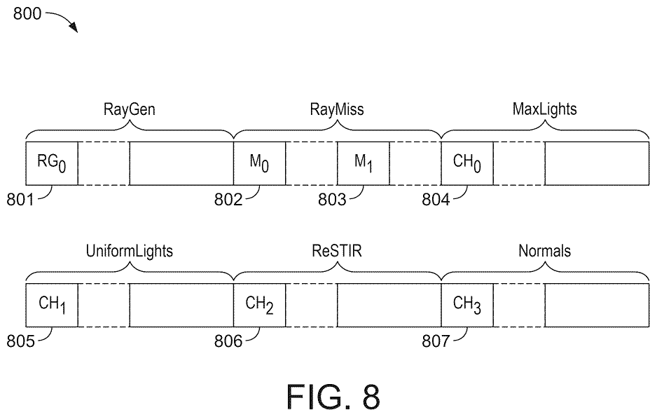

The application 13 may also provide a shader binding table (SBT) that identifies all of the shaders that may be executed to render a scene. FIG. 8 illustrates an exemplary shader binding table (SBT) 800. The shader binding table (SBT) 800 comprises a set of shader records that identify shaders and sets of parameters to be used when executing the shaders. Each shader is identified by a handle 801-807 that may indicate an address in memory 6 where the respective (compiled) shader will be stored.

In the example shown in FIG. 8, the shader binding table (SBT) 800 includes shader records for one ray generation shader, RG₀, two different miss shaders, M₀, M₁, and four different closest-hit shaders, CH₀, CH₁, CH₂, CH₃. Other numbers and types of shaders are possible. The shader binding table (SBT) may be updated dynamically, e.g. to account for moving geometry of a dynamic scene.

The shader binding table (SBT) is stored in a buffer in memory 6. To allow different hit shaders to be used for different instances/materials/geometries, hit shader handles 804-807 may be stored at offsets from the start of the buffer that can be determined dynamically (during ray tracing) from instance and/or geometry IDs. Then, during ray tracing, when a ray is found to intersect geometry, the instance and/or geometry ID for the intersected geometry can be used to determine the appropriate dynamic offset to use to find the hit shader handle 804-807 in the shader binding table (SBT) appropriate to the intersected geometry, and then use the memory address indicated by that handle to find the appropriate hit shader to execute.

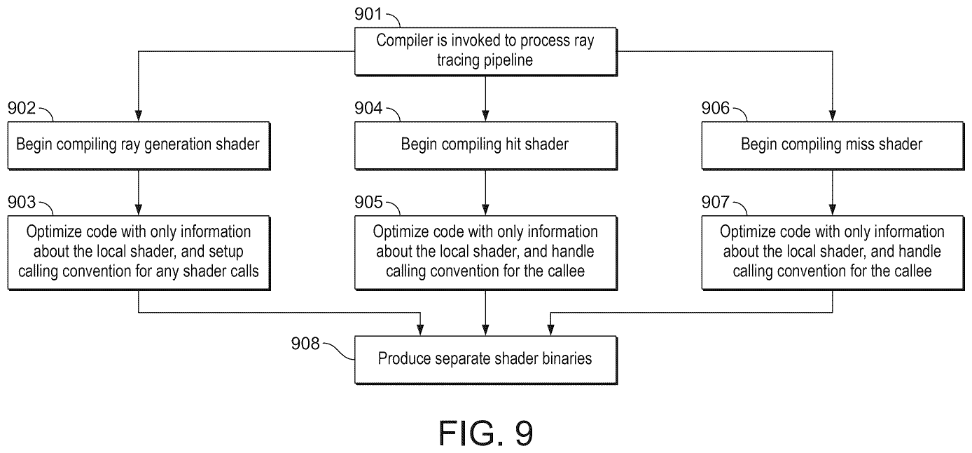

FIG. 9 shows a process by which the compiler 12 may compile such a set of application provided shader programs for execution by the graphics processor 2 (at step 32 of FIG. 3). As illustrated in FIG. 9, in response to application 13 providing a set of shaders including a ray generation shader, a hit shader and a miss shader (at step 901), the compiler 12 may compile and optimise the ray generation shader (at step 902 and 903), separately compile and optimise the hit shader (at step 904 and 905), and separately compile and optimise the miss shader (at step 906 and 907). The compiler 12 may then provide the separately compiled shaders to the graphics processor 2 for execution (at step 908).

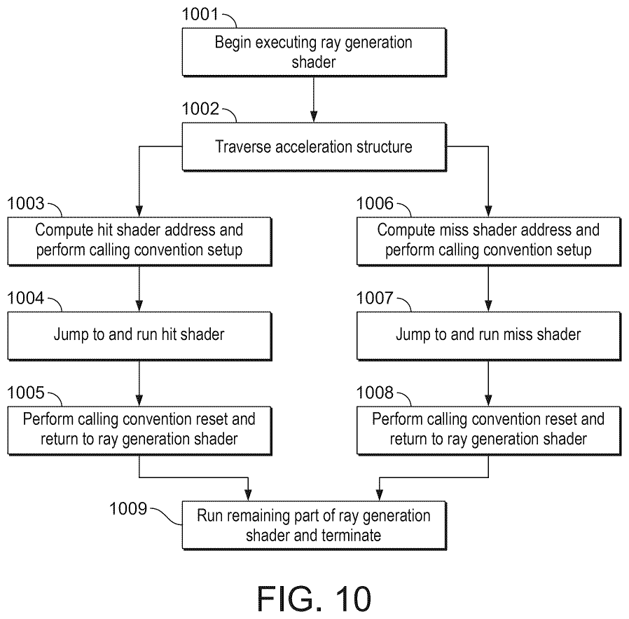

FIG. 10 shows a corresponding process by which the graphics processor 2 may execute separately compiled shaders to implement a ray tracing pipeline (at step 33 of FIG. 3). As illustrated in FIG. 10, the graphics processor 2 may first execute a ray generation shader (at step 1001) to generate a set of one or more rays to be traced, which rays are traversed through the acceleration data structure (at step 1002).

If a ray is found to intersect geometry, the graphics processor 2 may use the instance and/or geometry ID for the intersected geometry to determine a dynamic offset into the shader binding table (SBT) 800 to identify the appropriate (separately compiled) hit shader to execute (at step 1003), and execute the identified hit shader (at step 1004). The graphics processor 2 may then return to execution of the ray generation shader (at steps 1005 and 1009).

Similarly, if a ray is found not to intersect any geometry, the graphics processor 2 may use the shader binding table (SBT) 800 to identify the appropriate (separately compiled) miss shader to execute (at step 1006), and execute the identified miss shader (at step 1007). The graphics processor 2 may then return to execution of the ray generation shader (at steps 1008 and 1009).

The inventors have recognised that although the arrangement illustrated by FIGS. 9 and 10 can facilitate a high degree of flexibility, separately compiling different shader programs in this manner can limit opportunities for compiler optimisations. Furthermore, the process of switching between execution of separately compiled shaders at runtime (e.g. at steps 1003, 1005, 1006, 1008 of FIG. 10) can be particularly expensive to implement.

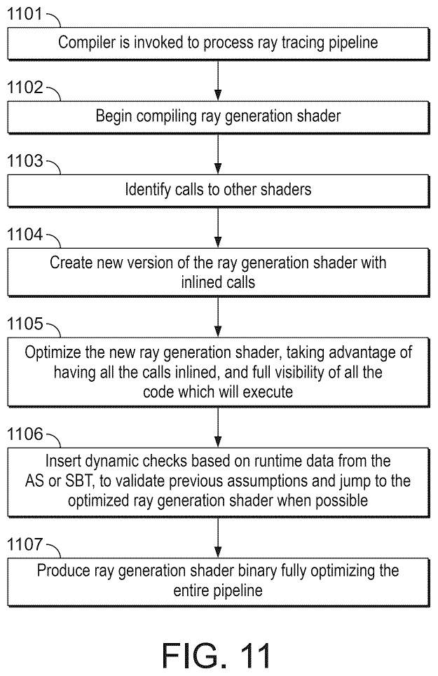

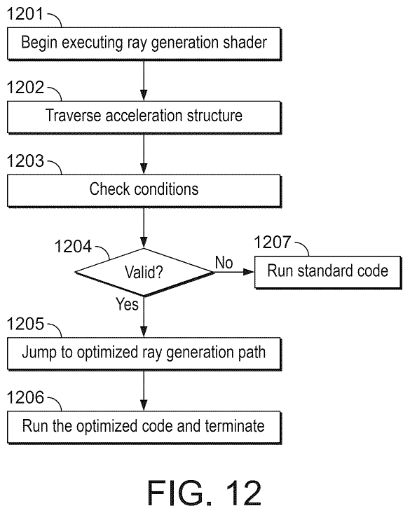

FIGS. 11 and 12 illustrate an improved arrangement in accordance with embodiments of the technology described herein. In this process, shaders that are called by a ray generation shader are “inlined” into the ray generation shader (i.e. calls to other shaders in the ray generation shader are replaced with instructions of the called shaders) by the compiler 12 to produce a single, “complete” compiled binary that represents an entire ray tracing pipeline. The inventors have found that producing a complete compiled shader program in this manner can increase opportunities for compiler optimisations, as well as avoid switching between execution of separately compiled shaders at runtime. This can improve efficiency and accelerate ray tracing.

FIG. 11 shows a process by which the compiler 12 may compile a set of application provided shader programs into a single (complete) binary for execution by the graphics processor 2 (at step 32 of FIG. 3). As illustrated in FIG. 11, in response to application 13 providing a set of shaders and a shader binding table (SBT) identifying the shaders (at step 1101), the compiler 12 begins by compiling a ray generation shader of the set of shaders (at step 1102), identifies opportunities to inline calls to other shaders into the ray generation shader (at step 1103), generates a version of the ray generation shader with calls to other shaders “inlined” (i.e. replaced with instructions of the called shaders) (at step 1104), and optimises this version of the ray generation shader (at step 1105).

As will be discussed in more detail below, to facilitate this process, the compiler 12 may make various assumptions regarding runtime information that will not be available to the compiler 12 at compile-time. To account for this, the compiler 12 may insert check instructions into the (single) ray generation shader to check that these compile-time assumptions are valid at runtime (at step 1106). The compiler 12 then provides the (single) complete compiled shader to the graphics processor 2 for execution (at step 1107).

Where plural ray generation shaders are provided, compiler 12 may generate a respective complete compiled shader for each ray generation shader. Alternatively, compiler 12 may combine plural ray generation shaders into a single compiled shader.

FIG. 12 shows a corresponding process by which the graphics processor 2 may execute a (single) complete compiled shader to implement a ray tracing pipeline (at step 33 of FIG. 3). As illustrated in FIG. 12, the graphics processor 2 executes the ray generation shader (at step 1201) to generate a set of one or more rays to be traced, which rays are traversed through the acceleration data structure (at step 1202).

The graphics processor 2 may execute the check instructions inserted into the ray generation shader by the compiler 12 (at step 1203) which cause the graphics processor 2 to check whether the compile-time assumptions made by the compiler 12 are valid (at step 1204). If the compile-time assumptions are determined to be valid, the graphics processor 2 continues executing the (complete) compiled ray generation shader to implement the entire ray tracing pipeline (at steps 1205 and 1206). Otherwise, if the compile-time assumptions are determined not to be valid, the graphics processor 2 may switch to executing separately compiled shaders to implement the ray tracing pipeline (at step 1207), e.g. as described above with reference to FIGS. 9 and 10.

Shader calls may be identified and inlined in any suitable manner.

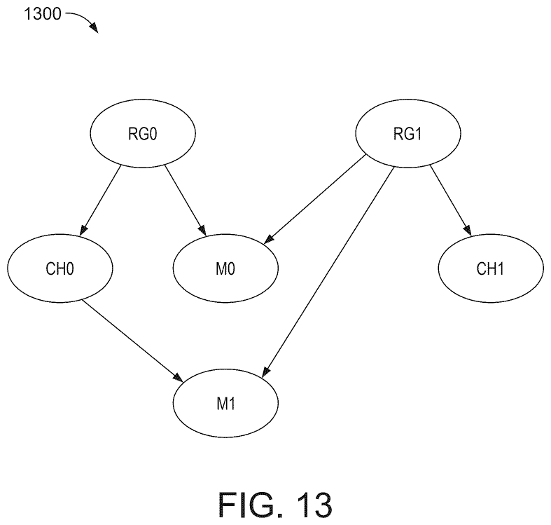

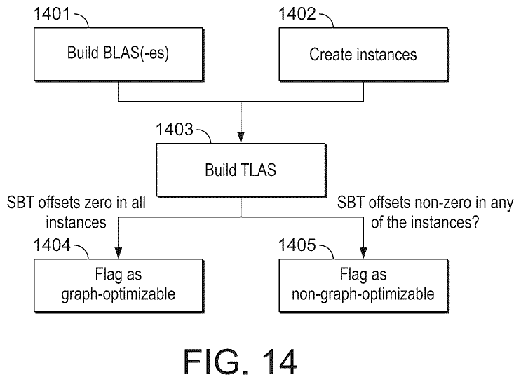

FIGS. 13 and 14 illustrate an embodiment in which the compiler 12 (at step 1103 of FIG. 11) uses the application provided shader programs and shader binding table (SBT) (that are available at compile-time) to effectively build an expected “call graph” that indicates which shaders are expected to call which other shaders (at runtime), and the shaders are inlined into a single compiled shader (at step 1104 of FIG. 11) based on the expected call graph.

In this embodiment, the compiler 12 may effectively assume that the identity of each shader to be called can be determined without runtime information, e.g. independently of geometry information (that is not available to the compiler 12 at compile-time). For example, where there are multiple different hit shaders identified by a shader binding table (SBT), the compiler 12 may effectively assume that the choice of which hit shader to run in response to geometry being found to be intersected will be independent of the instance and/or geometry ID for the intersected geometry (and thus independent of dynamic offsets into the shader binding table (SBT)).

For example, FIG. 13 illustrates a call graph 1300 built by compiler 12 based on a set of application provided shader programs that includes two ray generation shaders RG₀, RG₁ that represent different ray tracing modes, two miss shaders M₀, M₁, and two closest-hit shaders CH₀, CH₁. In this example, the compiler 12 may effectively assume that each closest-hit shader CH₀, CH₁ can only be called by a respective one of the ray generation shaders RG₀, RG₁. Similarly, the compiler 12 may effectively assume that miss shader M₀ will be called whenever a primary ray is found not to intersect any geometry, and miss shader M₁ will be called whenever a visibility ray is found not to intersect any geometry.

The compiler 12 may then produce one or more (complete) shader programs having control statements corresponding to the structure of the call graph 1300.

In this embodiment, whether or not runtime/geometry information needs to be taken into account to determine which shader to call can be confirmed when building an acceleration data structure representing the geometry (at step 31 of FIG. 3). This is illustrated by FIG. 14.

As illustrated in FIG. 14, a bottom-level acceleration structure (BLAS) is built for each instance (at steps 1401 and 1402), and then a top-level acceleration structure (TLAS) referencing the bottom-level acceleration structures (BLAS) is built (at step 1403). As part of this processing, instance/geometry IDs and offsets are determined and associated with each instance/BLAS, and this information is used to determine whether or not dynamic offsets into the shader binding table (SBT) may need to be used to determine which hit shader to call (at runtime) (and thus whether or not runtime/geometry information needs to be taken into account to determine which hit shader to call).

Information (e.g. a flag) indicating whether or not dynamic offsets into the shader binding table (SBT) may need to be used to determine which hit shader to call (at runtime) is then stored in association with the acceleration data structure (at step 1404 or 1405).

Correspondingly, the compiler 12 inserts instructions into the ray generation shader (at step 1106 of FIG. 11) to cause the graphics processor 2 to check this information (e.g. flag) (at runtime) (at step 1203 of FIG. 12) to determine whether runtime/geometry information needs to be taken into account to be able to determine which hit shader to call, and thus whether execution of the (complete) ray generation shader (which has been compiled assuming that this is the case) can continue. If it is found that runtime/geometry information does not need to be taken into account, it is determined that execution of the (complete) ray generation shader can continue.

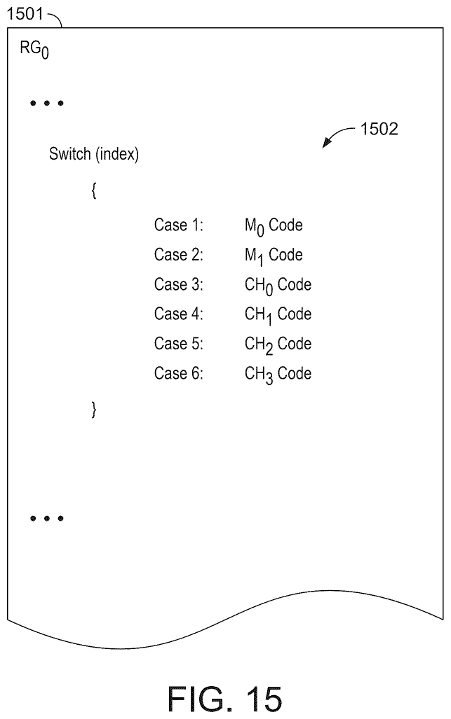

FIG. 15 illustrates another embodiment in which the compiler 12 uses the shader binding table (SBT) to identify and inline shaders that may be called by a ray generation shader. In this embodiment, the compiler 12 (at step 1103 of FIG. 11) assigns a unique index to each shader identified by the shader binding table (SBT), and the assigned indices are stored in the shader binding table (SBT) in the corresponding shader handles.

Then (at step 1104 of FIG. 11), the compiler 12 adds one or more switch statements to the ray generation shader that have cases for indexed shaders, with the assigned index being used as the control variable of the switch statement(s). The compiler 12 causes a (each) call to another shader in the ray generation shader to determine the appropriate index to use in a switch statement by looking up the corresponding shader handle in the shader binding table (SBT).

The compiler 12 may add a respective switch statement to a ray generation shader for each other type of shader identified by the shader binding table (SBT):
for example one switch statement for miss shaders, another switch statement for closest hit shaders, etc..

In the example illustrated by FIG. 15, the compiler 12 adds a switch statement to a ray generation shader for all other shaders identified by the shader binding table (SBT). For example, referring to the shader binding table (SBT) 800 of FIG. 8, the compiler 12 may assign index “0” to ray generation shader RG₀, index “1” to miss shader M₀, index “2” to miss shader M₁, and so on. As illustrated in FIG. 15, the compiler 12 may then add a switch statement 1502 to ray generation shader RG₀ 1501 that has a case for each other shader identified by the shader binding table (SBT) 800. A call to, for example, miss shader M₁ in ray generation shader RG₀ can then use the handle 803 for miss shader M₁ in the shader binding table (SBT) 800 to determine that index “2” has been assigned to miss shader M₁, and then use the determined index in the switch statement.

Other arrangements are possible.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

### CLAUSES

Clause 1. A method of providing a ray tracing shader program for execution by a graphics processor that is operable to perform ray tracing by executing ray tracing shader programs; the method comprising:
generating, from a set of ray tracing shader programs that define different elements of a ray tracing pipeline, a combined ray tracing shader program by combining instructions of different ray tracing shader programs of the set; and
providing the combined ray tracing shader program for execution by a graphics processor.
Clause 2. The method of clause 1, wherein the set of ray tracing shader programs includes a ray generation shader program and one or more other ray tracing shader programs; and
generating the combined ray tracing shader program comprises:
   replacing calls in the ray generation shader program to the one or more other ray tracing shader programs with instructions comprising instructions of the one or more other ray tracing shader programs.

Clause 3. The method of clause 2, wherein the one or more other ray tracing shader programs comprise one or more hit shader programs and one or more miss shader programs.

Clause 4. The method of any preceding clause, wherein generating the combined ray tracing shader program comprises:
associating unique identifiers with ray tracing shader programs of the set of ray tracing shader programs; and
including in the combined shader program one or more control instructions that will, when executed by the graphics processor, cause the graphics processor to select instructions to execute using the unique identifiers.

Clause 5. The method of any preceding clause, wherein generating the combined ray tracing shader program comprises:
building a call graph that indicates which ray tracing shader programs of the set call which other ray tracing shader programs of the set; and
combining instructions of different ray tracing shader programs of the set based on the call graph.

Clause 6. The method of any preceding clause, comprising using a shader binding table (SBT) that identifies ray tracing shader programs of the set to combine instructions of different ray tracing shader programs of the set.

Clause 7. The method of any preceding clause, comprising subjecting the combined ray tracing shader program to one or more compiler optimisation operations.

Clause 8. The method of any preceding clause, wherein one or more ray tracing shader programs of the set comprise one or more calls that will, when executed by the graphics processor, cause the graphics processor to execute another ray tracing shader program of the set;
generating the combined ray tracing shader program comprises combining instructions such that the combined ray tracing shader program will, when executed by the graphics processor, cause the graphics processor to implement a ray tracing pipeline without executing any other ray tracing shader program provided one or more conditions are met; and
the method comprises including in the combined ray tracing shader program one or more instructions that will, when executed by the graphics processor, cause the graphics processor to:
   determine whether the one or more conditions are met; and
   when it is determined that the one or more conditions are met, implement the ray tracing pipeline without executing any other ray tracing shader program.

Clause 9. The method of clause 8, wherein the graphics processor is operable to perform ray tracing by traversing rays through a ray tracing acceleration data structure; and
wherein the one or more instructions will, when executed by the graphics processor, cause the graphics processor to determine whether the one or more conditions are met based on one or more properties of a ray tracing acceleration data structure.

Clause 10. The method of clause 8 or 9, wherein the graphics processor is operable to perform ray tracing by traversing rays through a ray tracing acceleration data structure to determine whether the rays intersect geometry represented by the ray tracing acceleration data structure, and performing one or more ray tracing hit operations in response to determining that a ray intersects geometry represented by the ray tracing acceleration data structure; and
wherein the one or more instructions will, when executed by the graphics processor, cause the graphics processor to determine whether the one or more conditions are met using information stored in association with a ray tracing acceleration data structure; and
wherein the information indicates whether the ray tracing acceleration data structure is configured such that a ray tracing hit operation performed by the graphics processor in response to a ray being determined to intersect geometry represented by the ray tracing acceleration data structure may depend on the geometry that is intersected.

Clause 11. A method of providing a ray tracing acceleration data structure for traversal by a graphics processor that is operable to perform ray tracing by traversing rays through a ray tracing acceleration data structure to determine whether the rays intersect geometry represented by the ray tracing acceleration data structure, and performing one or more ray tracing hit operations in response to determining that a ray intersects geometry represented by the ray tracing acceleration data structure; the method comprising:
building a ray tracing acceleration data structure for traversal by the graphics processor;
determining whether the ray tracing acceleration data structure is configured such that a ray tracing hit operation performed by the graphics processor in response to a ray being determined to intersect geometry represented by the ray tracing acceleration data structure may depend on the geometry that is intersected; and
storing, in association with the ray tracing acceleration data structure, information indicating whether the ray tracing acceleration data structure is determined to be configured such that a ray tracing hit operation performed by the graphics processor in response to a ray being determined to intersect geometry represented by the ray tracing acceleration data structure may depend on the geometry that is intersected.

Clause 12. A method of operating a graphics processing system that comprises a graphics processor that is operable to perform ray tracing; the method comprising:
the graphics processor executing a combined ray tracing shader program provided according to the method of any one of clauses 1 to 10; and/or
the graphics processor traversing a ray tracing acceleration data structure provided according to the method of clause 11.

Clause 13. A computer program comprising computer software code for performing the method of any preceding clause when the program is run on data processing means.

Clause 14. An apparatus for providing ray tracing shader programs for execution by a graphics processor that is operable to perform ray tracing by executing ray tracing shader programs; the apparatus comprising:
a generating circuit configured to generate, from a set of ray tracing shader programs that define different elements of a ray tracing pipeline, a combined ray tracing shader program by combining instructions of different ray tracing shader programs of the set; and
a providing circuit configured to provide a combined ray tracing shader program generated by the generating circuit for execution by a graphics processor.

Clause 15. The apparatus of clause 14, wherein the set of ray tracing shader programs includes a ray generation shader program and one or more other ray tracing shader programs; and

the generating circuit is configured to generate a combined ray tracing shader program by:
replacing calls in the ray generation shader program to the one or more other ray tracing shader programs with instructions comprising instructions of the one or more other ray tracing shader programs.

Clause 16. The apparatus of clause 15, wherein the one or more other ray tracing shader programs comprise one or more hit shader programs and one or more miss shader programs.

Clause 17. The apparatus of any one of clauses 14 to 16, wherein the generating circuit is configured to generate a combined ray tracing shader program by:
associating unique identifiers with ray tracing shader programs of the set of ray tracing shader programs; and
including in the combined shader program one or more control instructions that will, when executed by the graphics processor, cause the graphics processor to select instructions to execute using the unique identifiers.

Clause 18. The apparatus of any one of clauses 14 to 17, wherein the generating circuit is configured to generate a combined ray tracing shader program by:
building a call graph that indicates which ray tracing shader programs of the set call which other ray tracing shader programs of the set; and
combining instructions of different ray tracing shader programs of the set based on the call graph.

Clause 19. The apparatus of any one of clauses 14 to 18, wherein the generating circuit is configured to combine instructions of different ray tracing shader programs of the set using a shader binding table (SBT) that identifies ray tracing shader programs of the set.

Clause 20. The apparatus of any one of clauses 14 to 19, wherein the providing circuit is configured to subject the combined ray tracing shader program to one or more compiler optimisation operations.

Clause 21. The apparatus of any one of clauses 14 to 20, wherein one or more ray tracing shader programs of the set comprise one or more calls that will, when executed by the graphics processor, cause the graphics processor to execute another ray tracing shader program of the set;
the generating circuit is configured to generate a combined ray tracing shader program by combining instructions such that the combined ray tracing shader program will, when executed by the graphics processor, cause the graphics processor to implement a ray tracing pipeline without executing any other ray tracing shader program provided one or more conditions are met; and
the generating circuit is configured to include in the combined ray tracing shader program one or more instructions that will, when executed by the graphics processor, cause the graphics processor to:
   determine whether the one or more conditions are met; and
   when it is determined that the one or more conditions are met, implement the ray tracing pipeline without executing any other ray tracing shader program.

Clause 22. The apparatus of clause 21, wherein the graphics processor is operable to perform ray tracing by traversing rays through a ray tracing acceleration data structure; and
wherein the one or more instructions will, when executed by the graphics processor, cause the graphics processor to determine whether the one or more conditions are met based on one or more properties of a ray tracing acceleration data structure.

Clause 23. The apparatus of clause 21 or 22, wherein the graphics processor is operable to perform ray tracing by traversing rays through a ray tracing acceleration data structure to determine whether the rays intersect geometry represented by the ray tracing acceleration data structure, and performing one or more ray tracing hit operations in response to determining that a ray intersects geometry represented by the ray tracing acceleration data structure; and
wherein the one or more instructions will, when executed by the graphics processor, cause the graphics processor to determine whether the one or more conditions are met using information stored in association with a ray tracing acceleration data structure; and
wherein the information indicates whether the ray tracing acceleration data structure is configured such that a ray tracing hit operation performed by the graphics processor in response to a ray being determined to intersect geometry represented by the ray tracing acceleration data structure may depend on the geometry that is intersected.

Clause 24. An apparatus for providing a ray tracing acceleration data structure for traversal by a graphics processor that is operable to perform ray tracing by traversing rays through a ray tracing acceleration data structure to determine whether the rays intersect geometry represented by the ray tracing acceleration data structure, and performing one or more ray tracing hit operations in response to determining that a ray intersects geometry represented by the ray tracing acceleration data structure; the apparatus comprising:
a building circuit configured to build a ray tracing acceleration data structure for traversal by the graphics processor; and
a processing circuit configured to:
determine whether a ray tracing acceleration data structure built by the building circuit is configured such that a ray tracing hit operation performed by the graphics processor in response to a ray being determined to intersect geometry represented by the ray tracing acceleration data structure may depend on the geometry that is intersected; and
store, in association with the ray tracing acceleration data structure, information indicating whether the ray tracing acceleration data structure is determined to be configured such that a ray tracing hit operation performed by the graphics processor in response to a ray being determined to intersect geometry represented by the ray tracing acceleration data structure may depend on the geometry that is intersected.
Clause 25. A graphics processing system comprising:
a graphics processor operable to perform ray tracing; and
the apparatus of any one of clauses 14 to 23; and/or
the apparatus of clause 24.

1. A method of providing a ray tracing shader program for execution by a graphics processor that is operable to perform ray tracing by executing ray tracing shader programs; the method comprising:
generating, from a set of ray tracing shader programs that define different elements of a ray tracing pipeline, a combined ray tracing shader program by combining instructions of different ray tracing shader programs of the set; and
providing the combined ray tracing shader program for execution by a graphics processor.

2. The method of claim 1, wherein the set of ray tracing shader programs includes a ray generation shader program and one or more other ray tracing shader programs; and
generating the combined ray tracing shader program comprises:
replacing calls in the ray generation shader program to the one or more other ray tracing shader programs with instructions comprising instructions of the one or more other ray tracing shader programs.

3. The method of claim 1, wherein generating the combined ray tracing shader program comprises:
associating unique identifiers with ray tracing shader programs of the set of ray tracing shader programs;
storing the unique identifiers in a shader binding table (SBT) that identifies the ray tracing shader programs of the set; and
including in the combined shader program one or more control instructions that will, when executed by the graphics processor, cause the graphics processor to select instructions to execute using the unique identifiers stored in the shader binding table (SBT).

4. The method of claim 1, wherein generating the combined ray tracing shader program comprises:
building a call graph that indicates which ray tracing shader programs of the set call which other ray tracing shader programs of the set; and
combining instructions of different ray tracing shader programs of the set based on the call graph.

5. The method of claim 1, comprising subjecting the combined ray tracing shader program to one or more compiler optimisation operations.

6. The method of claim 1, wherein one or more ray tracing shader programs of the set comprise one or more calls that will, when executed by the graphics processor, cause the graphics processor to execute another ray tracing shader program of the set;
generating the combined ray tracing shader program comprises combining instructions such that the combined ray tracing shader program will, when executed by the graphics processor, cause the graphics processor to implement a ray tracing pipeline without executing any other ray tracing shader program provided one or more conditions are met; and
the method comprises including in the combined ray tracing shader program one or more instructions that will, when executed by the graphics processor, cause the graphics processor to:
determine whether the one or more conditions are met; and
when it is determined that the one or more conditions are met, implement the ray tracing pipeline without executing any other ray tracing shader program.

7. The method of claim 1, wherein the graphics processor is operable to perform ray tracing by traversing rays through a ray tracing acceleration data structure; and
the method comprises including in the combined ray tracing shader program one or more instructions that will, when executed by the graphics processor, cause the graphics processor to:
determine whether information stored in association with a ray tracing acceleration data structure indicates that one or more conditions are met; and
when it is determined that information stored in association with a ray tracing acceleration data structure indicates that one or more conditions are met:
continue execution of the combined ray tracing shader program; and
traverse rays through the ray tracing acceleration data structure.

8. The method of claim 1, wherein the graphics processor is operable to
perform ray tracing by traversing rays through a ray tracing acceleration data structure to determine whether the rays intersect geometry represented by the ray tracing acceleration data structure, and performing one or more ray tracing hit operations in response to determining that a ray intersects geometry represented by the ray tracing acceleration data structure; and
the method comprises including in the combined ray tracing shader program one or more instructions that will, when executed by the graphics processor, cause the graphics processor to:
determine whether information stored in association with a ray tracing acceleration data structure indicates that the ray tracing acceleration data structure is configured such that a ray tracing hit operation performed by the graphics processor in response to a ray being determined to intersect geometry represented by the ray tracing acceleration data structure will not depend on the geometry that is intersected; and
when it is determined that the information indicates that the ray tracing acceleration data structure is configured such that a ray tracing hit operation performed by the graphics processor in response to a ray being determined to intersect geometry represented by the ray tracing acceleration data structure will not depend on the geometry that is intersected:
continue execution of the combined ray tracing shader program; and
traverse rays through the ray tracing acceleration data structure.

9. A method of providing a ray tracing acceleration data structure for traversal by a graphics processor that is operable to perform ray tracing by traversing rays through a ray tracing acceleration data structure to determine whether the rays intersect geometry represented by the ray tracing acceleration data structure, and performing one or more ray tracing hit operations in response to determining that a ray intersects geometry represented by the ray tracing acceleration data structure; the method comprising:
building a ray tracing acceleration data structure for traversal by the graphics processor;
determining whether the ray tracing acceleration data structure is configured such that a ray tracing hit operation performed by the graphics processor in response to a ray being determined to intersect geometry represented by the ray tracing acceleration data structure may depend on the geometry that is intersected; and
storing, in association with the ray tracing acceleration data structure, information indicating whether the ray tracing acceleration data structure is determined to be configured such that a ray tracing hit operation performed by the graphics processor in response to a ray being determined to intersect geometry represented by the ray tracing acceleration data structure may depend on the geometry that is intersected.

10. A method of operating a graphics processing system that comprises a graphics processor that is operable to perform ray tracing; the method comprising:
the graphics processor executing a combined ray tracing shader program provided according to the method of claim 1.

11. A non-transitory computer readable storage medium storing software code which when executing on a processor performs the method of claim 1.

12. An apparatus for providing ray tracing shader programs for execution by a graphics processor that is operable to perform ray tracing by executing ray tracing shader programs; the apparatus comprising:
a generating circuit configured to generate, from a set of ray tracing shader programs that define different elements of a ray tracing pipeline, a combined ray tracing shader program by combining instructions of different ray tracing shader programs of the set; and
a providing circuit configured to provide a combined ray tracing shader program generated by the generating circuit for execution by a graphics processor.

13. The apparatus of claim 12, wherein the set of ray tracing shader programs includes a ray generation shader program and one or more other ray tracing shader programs; and
the generating circuit is configured to generate a combined ray tracing shader program by:
replacing calls in the ray generation shader program to the one or more other ray tracing shader programs with instructions comprising instructions of the one or more other ray tracing shader programs.

14. The apparatus of claim 12, wherein the generating circuit is configured to generate a combined ray tracing shader program by:
associating unique identifiers with ray tracing shader programs of the set of ray tracing shader programs;
storing the unique identifiers in a shader binding table (SBT) that identifies the ray tracing shader programs of the set; and
including in the combined shader program one or more control instructions that will, when executed by the graphics processor, cause the graphics processor to select instructions to execute using the unique identifiers stored in the shader binding table (SBT).

15. The apparatus of claim 12, wherein the providing circuit is configured to subject the combined ray tracing shader program to one or more compiler optimisation operations.

16. The apparatus of claim 12, wherein one or more ray tracing shader programs of the set comprise one or more calls that will, when executed by the graphics processor, cause the graphics processor to execute another ray tracing shader program of the set;
the generating circuit is configured to generate a combined ray tracing shader program by combining instructions such that the combined ray tracing shader program will, when executed by the graphics processor, cause the graphics processor to implement a ray tracing pipeline without executing any other ray tracing shader program provided one or more conditions are met; and
the generating circuit is configured to include in the combined ray tracing shader program one or more instructions that will, when executed by the graphics processor, cause the graphics processor to:
determine whether the one or more conditions are met; and
when it is determined that the one or more conditions are met, implement the ray tracing pipeline without executing any other ray tracing shader program.

17. The apparatus of claim 12, wherein the graphics processor is operable to perform ray tracing by traversing rays through a ray tracing acceleration data structure; and
the generating circuit is configured to include in the combined ray tracing shader program one or more instructions that will, when executed by the graphics processor, cause the graphics processor to:
determine whether information stored in association with a ray tracing acceleration data structure indicates that one or more conditions are met; and
when it is determined that information stored in association with a ray tracing acceleration data structure indicates that one or more conditions are met:
continue execution of the combined ray tracing shader program; and
traverse rays through the ray tracing acceleration data structure.

18. The apparatus of claim 12, wherein the graphics processor is operable to perform ray tracing by traversing rays through a ray tracing acceleration data structure to determine whether the rays intersect geometry represented by the ray tracing acceleration data structure, and performing one or more ray tracing hit operations in response to determining that a ray intersects geometry represented by the ray tracing acceleration data structure; and
the generating circuit is configured to include in the combined ray tracing shader program one or more instructions that will, when executed by the graphics processor, cause the graphics processor to:
determine whether information stored in association with a ray tracing acceleration data structure indicates that the ray tracing acceleration data structure is configured such that a ray tracing hit operation performed by the graphics processor in response to a ray being determined to intersect geometry represented by the ray tracing acceleration data structure will not depend on the geometry that is intersected; and
when it is determined that the information indicates that the ray tracing acceleration data structure is configured such that a ray tracing hit operation performed by the graphics processor in response to a ray being determined to intersect geometry represented by the ray tracing acceleration data structure will not depend on the geometry that is intersected:
continue execution of the combined ray tracing shader program; and
traverse rays through the ray tracing acceleration data structure.

19. The apparatus of claim 18, further comprising:
a building circuit configured to build a ray tracing acceleration data structure for traversal by the graphics processor; and
a processing circuit configured to:
determine whether a ray tracing acceleration data structure built by the building circuit is configured such that a ray tracing hit operation performed by the graphics processor in response to a ray being determined to intersect geometry represented by the ray tracing acceleration data structure may depend on the geometry that is intersected; and
store, in association with the ray tracing acceleration data structure, information indicating whether the ray tracing acceleration data structure is determined to be configured such that a ray tracing hit operation performed by the graphics processor in response to a ray being determined to intersect geometry represented by the ray tracing acceleration data structure may depend on the geometry that is intersected.

20. A graphics processing system comprising:
a graphics processor operable to perform ray tracing; and
the apparatus of claim 12.
